(19) United States
(12) Patent Application Publication
(10) Pub. No.: US 2016/0354917 A1
(43) Pub. Date: Dec. 8, 2016

(54) MULTI-DRIVER TOOL

(71) Applicant: Irwin Industrial Tool Company, Huntersville, NC (US)

(72) Inventors: Gregory David Parker, Charlotte, NC (US); Norman John LeBlanc, Davidson, NC (US)

(21) Appl. No.: 15/172,073

(22) Filed: Jun. 2, 2016

Related U.S. Application Data
(60) Provisional application No. 62/169,716, filed on Jun. 2, 2015.

(51) Int. Cl. B25G 1/08; B25G 1/10; B25B 15/02

(52) U.S. Cl. CPC B25G 1/085; B25B 15/02; B25G 1/102

(57) ABSTRACT

A multi-driver tool may include a handle, a shaft removably attached to the handle, and a plurality of heads removably attached to the shaft. The handle may include an internal cavity, and the shaft may be positioned partially within the internal cavity when the shaft is attached to the handle. One of the heads may be attached to the shaft and positioned entirely outside of the handle when the shaft is attached to the handle, and one or more of the heads may be attached to the shaft and positioned entirely within the internal cavity when the shaft is attached to the handle.

### CROSS-REFERENCE TO RELATED APPLICATIONS

The present application claims priority to and the benefit of U.S. Provisional Application No. 62/169,716, filed on Jun. 2, 2015, entitled “MULTI-DRIVER TOOL,” which is hereby incorporated herein by reference in its entirety.

### FIELD OF THE DISCLOSURE

The present disclosure relates generally to hand tools and more particularly to a multi-driver tool for driving nuts, screws, and/or other types of fasteners.

### BACKGROUND

Various types of hand tools are known in the art for driving nuts, screws, and/or other types of fasteners. For example, conventional handheld drivers generally may include a handle and a shaft fixedly attached to the handle and having a working end configured to drive a fastener. It is common for tradesmen and other frequent users of hand tools to have sets of multiple conventional nut-drivers, screwdrivers, and other types of fastener-drivers of various sizes and configurations, with each driver being sized and configured to drive a particular fastener size and configuration. However, it may be cumbersome and time-consuming for a user to transport full sets of conventional drivers to a particular worksite and to select an appropriate driver from a set for use with a particular fastener. Moreover, if one of the drivers becomes lost or the working end of one of the drivers becomes damaged, the user may be required to purchase a replacement driver in order to be able to drive the corresponding fastener size and configuration. These problems led to the development of multi-driver tools, which generally may include a handle, a shaft attached to the handle, and a number of heads, such as sockets or bits, configured to removably attach to a working end of the shaft and to drive a fastener. Each head may be sized and configured to drive a particular fastener size and configuration, such that the multi-driver tool may be used to drive multiple fastener sizes and configurations. In this manner, a user may effectively replace multiple conventional drivers with a single multi-driver tool, thereby easing transport of the necessary hand tools to a particular worksite as well as selection of an appropriate driver for use with a particular fastener. Moreover, if one of the heads of the multi-driver tool becomes lost or damaged, the user need only purchase a replacement head in order to be able to drive the corresponding fastener size and configuration.

Various types of multi-driver tools that include a handle, a shaft, and a number of heads are known in the art. However, conventional multi-driver tools may present certain problems. According to certain conventional multi-driver tools, one of the heads may be attached to the working end of the shaft for use while the remaining heads are stored in a case separate from the tool. Notably, this configuration may be cumbersome for a user who must remember to bring the case along with the multi-driver tool to a particular worksite and must remove one of the heads from the case and return one of the heads to the case during each head change-out in order to avoid losing the heads. According to other conventional multi-driver tools, one of the heads may be attached to the working end of the shaft for use while the remaining heads are stored around or alongside an outer surface of the handle. This configuration, however, may result in an undesirably bulky handle and may inhibit a user's ability to grasp the handle in an ergonomic manner with the user's driving hand. According to still other conventional multi-driver tools, one of the heads may be attached to the working end of the shaft for use while the remaining heads are stored within the handle and accessed by opening the proximal end of the handle. Notably, this configuration may result in an undesirably bulky handle, may inhibit a user's ability to grasp the handle in an ergonomic manner with the user's driving hand, and may be cumbersome for the user to open the handle, remove one or more of the heads from the handle, and return one or more of the heads to the handle during each head change-out. According to other conventional multi-driver tools, one of the heads may be attached to the working end of the shaft for use while the remaining heads are stored around or alongside the shaft. This configuration, however, may result in an undesirably small shaft diameter necessary to accommodate smaller heads, such as sockets, stored around the shaft, may result in undesirable nesting of certain heads, such as sockets, stored around the shaft, may inhibit a user's ability to grasp the shaft in an ergonomic manner with the user's supporting hand, and may be cumbersome for the user to remove one or more of the heads from the shaft and return one or more of the heads to the shaft during each head change-out. Additional problems presented by certain conventional multi-driver tools include difficulty visualizing a head attached to the working end of the shaft and engaging a fastener with the head, undesirable bulkiness of the handle or the shaft, and difficulty changing out the head attached to the working end.

### BRIEF DESCRIPTION OF THE DRAWINGS

The detailed description is set forth with reference to the accompanying drawings. The use of the same reference numerals may indicate similar or identical items. Various embodiments may utilize elements and/or features other than those illustrated in the drawings, and some elements and/or features may not be present in various embodiments. Elements and/or features in the drawings are not necessarily drawn to scale. Throughout this disclosure, depending on the context, singular and plural terminology may be used interchangeably.

FIG. 1A is a perspective view of a multi-driver tool in accordance with one or more example embodiments of the disclosure.

FIG. 1B is a cross-sectional perspective view of the multi-driver tool of FIG. 1A, taken along line 1B-1B of FIG. 1A.

FIG. 1C is a partially-exploded perspective view of a portion of the multi-driver tool of FIG. 1A.

FIG. 1D is a partially-exploded perspective view of a portion of the multi-driver tool of FIG. 1A.

FIG. 1E is a partially-exploded perspective view of a portion of the multi-driver tool of FIG. 1A.

FIG. 1F is a cross-sectional side view of a head of the multi-driver tool of FIG. 1A.

FIG. 2A is a perspective view of a multi-driver tool in accordance with one or more example embodiments of the disclosure.

FIG. 2B is a cross-sectional perspective view of the multi-driver tool of FIG. 2A, taken along line 2B-2B of FIG. 2A.

FIG. 2C is a partially-exploded perspective view of a portion of the multi-driver tool of FIG. 2A.

FIG. 2D is a partially-exploded perspective view of a portion of the multi-driver tool of FIG. 2A.

FIG. 2E is a partially-exploded perspective view of a portion of the multi-driver tool of FIG. 2A.

FIG. 2F is a cross-sectional side view of a head of the multi-driver tool of FIG. 2A.

FIG. 3A is a perspective view of a multi-driver tool in accordance with one or more example embodiments of the disclosure.

FIG. 3B is a cross-sectional perspective view of the multi-driver tool of FIG. 3A, taken along line 3B-3B of FIG. 3A.

FIG. 3C is a perspective view of a portion of the multi-driver tool of FIG. 3A.

FIG. 3D is a partially-exploded perspective view of a portion of the multi-driver tool of FIG. 3A.

FIG. 3E is a cross-sectional perspective view of a portion of the multi-driver tool of FIG. 3A, taken along line 3E-3E of FIG. 3C.

FIG. 4A is a perspective view of a multi-driver tool in accordance with one or more example embodiments of the disclosure.

FIG. 4B is a cross-sectional perspective view of the multi-driver tool of FIG. 4A, taken along line 4B-4B of FIG. 4A.

FIG. 4C is a perspective view of a portion of the multi-driver tool of FIG. 4A.

FIG. 4D is a partially-exploded perspective view of a portion of the multi-driver tool of FIG. 4A.

FIG. 4E is a cross-sectional perspective view of a portion of the multi-driver tool of FIG. 4A, taken along line 4E-4E of FIG. 4C.

### DETAILED DESCRIPTION OF EXAMPLE EMBODIMENTS

### Overview

Described below are example embodiments of a multi-driver tool as well as individual features of the multi-driver tool. The multi-driver tool may be used in various applications to drive nuts, screws, and/or other types of fasteners. As described below, the multi-driver tool may include a handle, a shaft removably attached to the handle, and a number of heads each removably attached to the shaft. The multi-driver tool may have an assembled configuration for driving a fastener with one of the heads, in which the shaft is attached to and positioned partially within the handle, one of the heads is attached to the shaft and positioned entirely outside of the handle, and one or more of the heads is attached to the shaft and positioned entirely within the handle. In this manner, when the multi-driver tool is in the assembled configuration, the one of the heads may be used to drive a fastener, while the one or more of the heads may be stored and protected within the handle. The multi-driver tool also may have a disassembled configuration for changing out the head to be used to drive a fastener, in which the shaft is detached from and positioned entirely outside of the handle. In this manner, when the multi-driver tool is in the disassembled position, a user may detach two or more of the heads from the shaft and reattach the heads to the shaft in different positions, with a desired one of the heads in position to drive a fastener.

As compared to certain conventional multi-driver tools, embodiments of the multi-driver tool may provide a compact and convenient configuration for securely storing and protecting multiple heads within the handle of the tool, may allow a user to change out the heads of the tool in a straightforward and efficient manner, may allow a user to grasp the handle of the tool in an ergonomic manner with the user's driving hand without disturbing the heads of the tool, may allow a user to grasp the shaft of the tool in an ergonomic manner with the user's supporting hand without disturbing the heads of the tool, may allow a user to easily visualize a head attached to a working end of the shaft of the tool and engage a fastener with the head, may avoid the need for an undesirably bulky handle of the tool, and/or may allow a user to store commonly-used heads of the tool in an easily accessible position.

According to one aspect, a multi-driver tool may include a handle, a shaft removably attached to the handle, and a number of heads removably attached to the shaft. The handle may include an internal cavity, and the shaft may be positioned partially within the internal cavity when the shaft is attached to the handle. One of the heads may be attached to the shaft and positioned entirely outside of the handle when the shaft is attached to the handle, and one or more of the heads may be attached to the shaft and positioned entirely within the internal cavity when the shaft is attached to the handle.

In certain example embodiments, the handle may include an opening defined in a distal end of the handle and in communication with the internal cavity, and the shaft may extend through the opening when the shaft is attached to the handle. In certain example embodiments, the shaft may include an interface section configured to removably attach the shaft to the handle, and the interface section may be positioned at least partially within the internal cavity when the shaft is attached to the handle. In certain example embodiments, the interface section may include a receptacle defined in the interface section, a ball received within the receptacle, and a spring received within the receptacle and configured to bias the ball.

In certain example embodiments, the shaft may include a working section configured to removably attach the one of the heads to the shaft, and the working section may be positioned entirely outside of the handle when the shaft is attached to the handle. In certain example embodiments, the working section may include a head connector positioned at a distal end of the working section, and the head connector may include: (i) an elongated member configured to be received within the one of the heads; or (ii) a head cavity configured to receive the one of the heads therein. In certain example embodiments, the working section may include: (i) a receptacle defined in the head connector, a ball received within the receptacle, and a spring received within the receptacle and configured to bias the ball; or (ii) a magnet positioned within the head cavity.

In certain example embodiments, the shaft may include a holder section configured to removably attach the one or more of the heads to the shaft, and the holder section may be positioned entirely within the internal cavity when the shaft is attached to the handle. In certain example embodiments, the holder section may include a head connector positioned at a proximal end of the holder section, and the head connector may include: (i) an elongated member configured to be received within the one or more of the heads; or (ii) a number of head cavities configured to receive the one or more of the heads therein. In certain example embodiments, the head connector may include: (i) a receptacle defined in the head connector, a ball received within the receptacle, and a spring received within the receptacle and configured to bias the ball; or (ii) a magnet positioned within each of the head cavities.

In certain example embodiments, the multi-driver tool may include an insert bolster fixedly attached to the handle and positioned at least partially within the internal cavity, and the shaft may be removably attached to the handle by the insert bolster. In certain example embodiments, the shaft may include a projection extending along a longitudinal axis of the shaft, the insert bolster may include a projection receptacle defined therein, and the projection may be received within the projection receptacle when the shaft is attached to the handle such that the shaft rotates with the handle. In certain example embodiments, each of the heads may include a first socket extending from a first end of the head and a second socket extending from a second end of the head, and the first socket and the second socket may have different sizes or cross-sectional shapes. In certain example embodiments, each of the heads may include an engagement section and one or more functional tips extending from the engagement section and configured to drive a fastener.

According to another aspect, a multi-driver tool may include a handle, a shaft removably attached to the handle, and a number of heads removably attached to the shaft. The shaft may be positioned partially within the handle when the shaft is attached to the handle. One of the heads may be attached to the shaft and positioned entirely outside of the handle when the shaft is attached to the handle, and one or more of the heads may be attached to the shaft and positioned entirely within the handle when the shaft is attached to the handle.

In certain example embodiments, the shaft may include an interface section configured to removably attach the shaft to the handle, a working section configured to removably attach the one of the heads to the shaft, and a holder section configured to removably attach the one or more of the heads to the shaft. The interface section may be positioned at least partially within the handle when the shaft is attached to the handle, the working section may be positioned entirely outside of the handle when the shaft is attached to the handle, and the holder section may be positioned entirely within the handle when the shaft is attached to the handle. In certain example embodiments, each of the heads may include a first socket extending from a first end of the head and a second socket extending from a second end of the head, and the first socket and the second socket may have different sizes or cross-sectional shapes. In certain example embodiments, each of the heads may include an engagement section and one or more functional tips extending from the engagement section and configured to drive a fastener.

According to still another aspect, a multi-driver tool may include a handle and a shaft attached to the handle. The shaft may include a head cavity extending from a distal end of the shaft to an internal end of the head cavity and configured to removably receive a head therein, and a slot defined in the shaft and in communication with the head cavity. In certain example embodiments, the slot may extend along the longitudinal axis of the shaft and include a distal end spaced apart from the distal end of the shaft and a proximal end positioned at or near an internal end of the head cavity.

According to another aspect, a tool bit holder may include an elongated member including a first end and a second end, a tool bit cavity extending from the first end or the second end of the elongated member to an internal end of the tool bit cavity, and a slot in communication with the tool bit cavity. The tool bit cavity may have a hexagonal cross-sectional shape and may be configured to receive at least a portion of a tool bit therein. The slot may extend from an external surface of the elongated member to the tool bit cavity.

These and other example embodiments of the disclosure are described in more detail through reference to the accompanying drawings in the detailed description that follows. This brief overview, including section titles and corresponding summaries, is provided for the reader's convenience and is not intended to limit the scope of the claims or the preceding sections. Furthermore, the techniques described above and below may be implemented in a number of ways and in a number of contexts. Several example implementations and contexts are provided with reference to the accompanying drawings, as described below in more detail. However, the following implementations and contexts are but a few of many.

Certain components and features of the multi-driver tool are described herein with reference to example embodiments illustrated in the drawings; however, such components and features are not limited to the example embodiments illustrated in the drawings. Certain components and features of the multi-driver tool are described herein as having a length extending relative to an x-axis, a width extending relative to a y-axis, and/or a height or thickness extending relative to a z-axis. The respective axes are shown in the drawings with respect to the multi-driver tool or components thereof.

Certain components and features of the multi-driver tool are described herein using the terms “proximal” and “distal.” It will be understood that these terms are used to describe a relative position of a component or feature of the multi-driver tool along the length of the multi-driver tool when the multi-driver tool is held by a user in a particular orientation, such as an orientation shown in the drawings. Certain components and features of the multi-driver tool are described herein using the terms “top,” “bottom,” “front,” “back,” or “side.” It will be understood that these terms are used to describe a relative position of a component or feature of the multi-driver tool when the multi-driver tool is in a particular orientation, such as an orientation shown in the drawings. Certain relationships between components or features of the multi-driver tool are described herein using the terms “above,” “below,” “in front of,” “behind,” “upper,” “lower,” “horizontal,” or “vertical.” It will be understood that these terms are used to describe a relative relationship between two or more components or features of the multi-driver tool when the multi-driver tool is in a particular orientation, such as an orientation shown in the drawings.

Certain components and features of the multi-driver tool are described herein using the terms “first,” “second,” “third,” etc. These terms are used only to distinguish one component or feature from another identical or similar component or feature. For example, a “first” component or feature could be termed a “second” component or feature, and, similarly, a “second” component or feature could be termed a “first” component or feature, without departing from the scope of the disclosure. Additionally, as used herein the term “and/or” includes any and all combinations of one or more of the associated listed items.

Certain dimensions of components and features of the multi-driver tool are described herein using the term “approximately.” As used herein, the term “approximately” indicates that each of the described dimensions is not a strict boundary or parameter and does not exclude functionally similar variations therefrom. Unless context or the description indicates otherwise, the use of the term “approximately” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

### ILLUSTRATIVE EMBODIMENTS

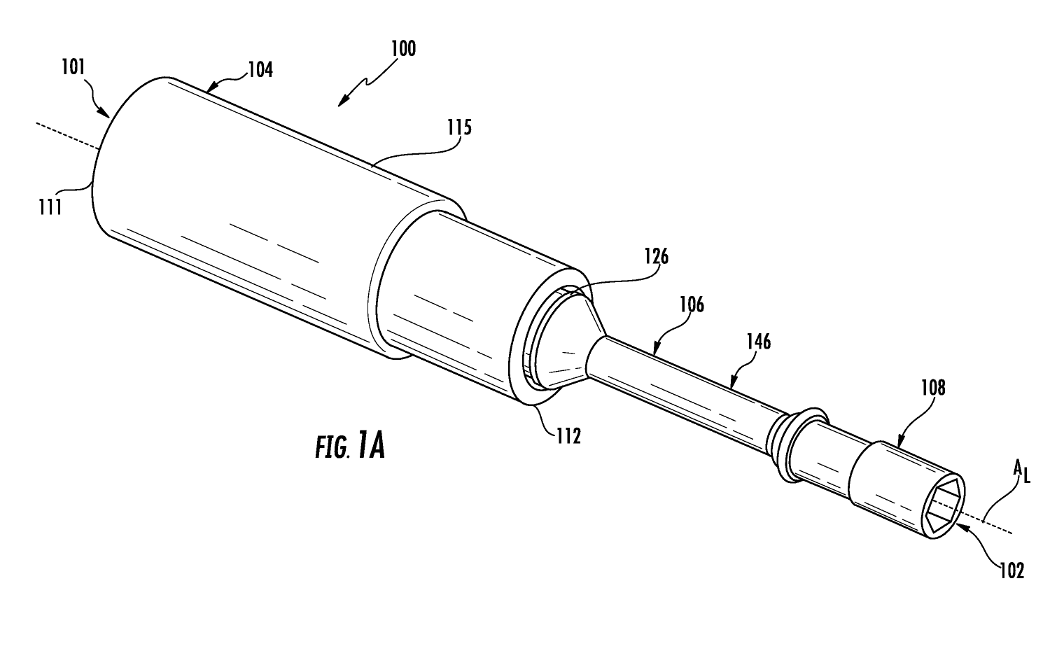

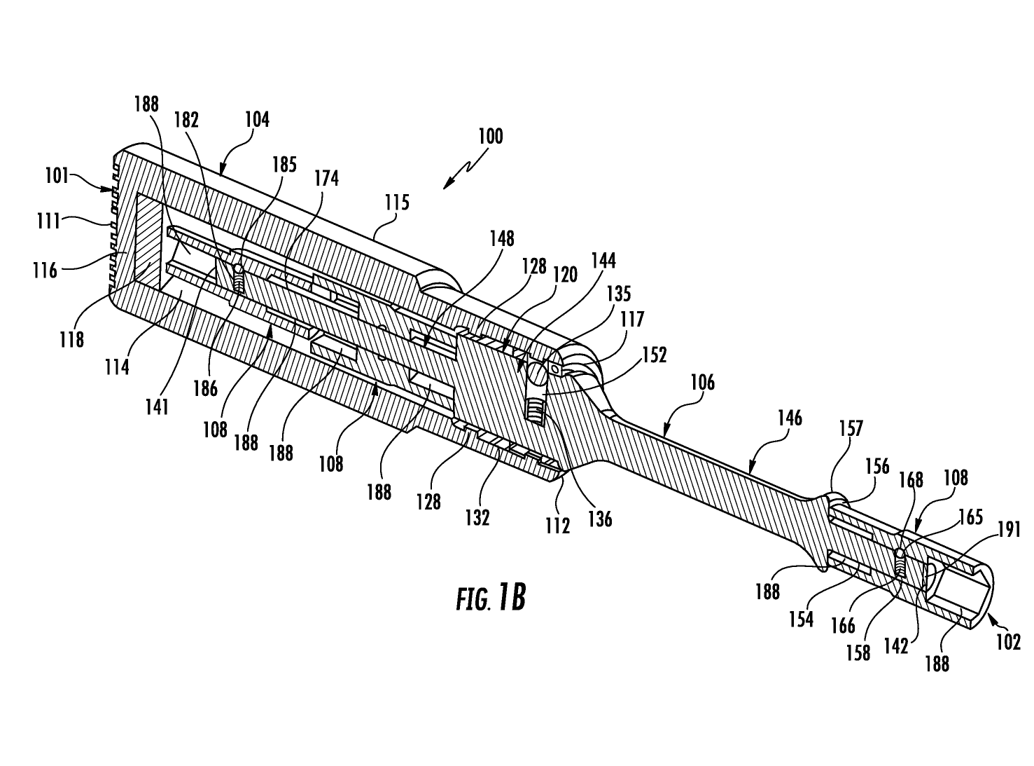

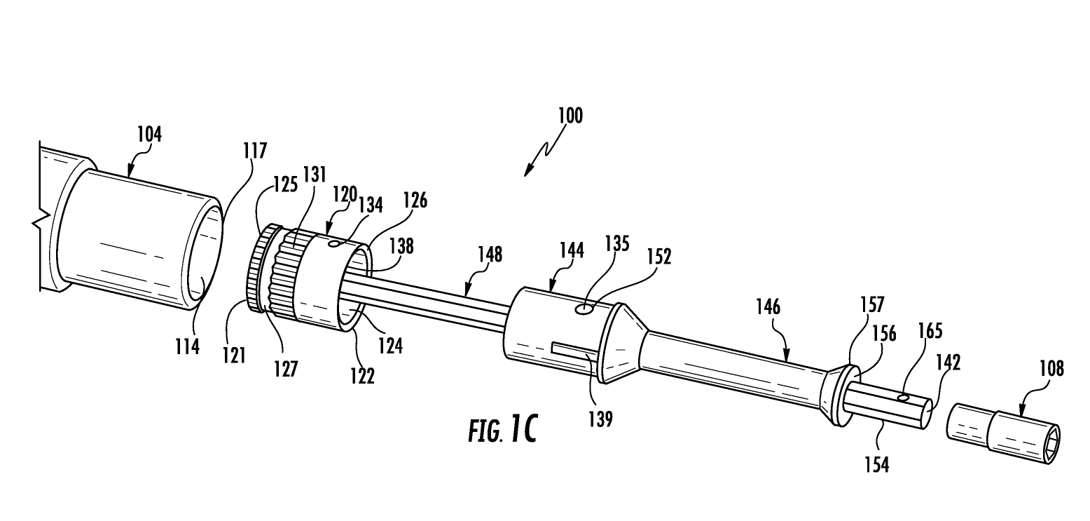

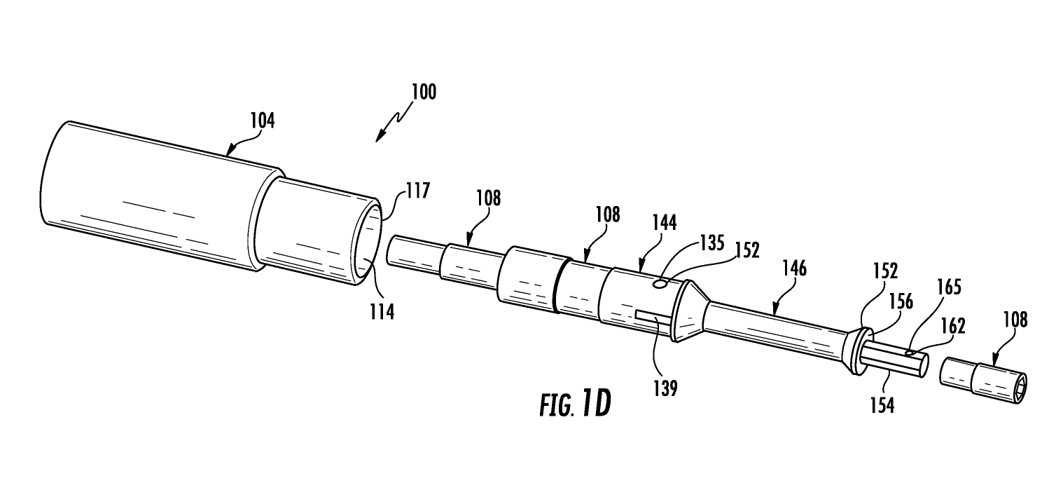

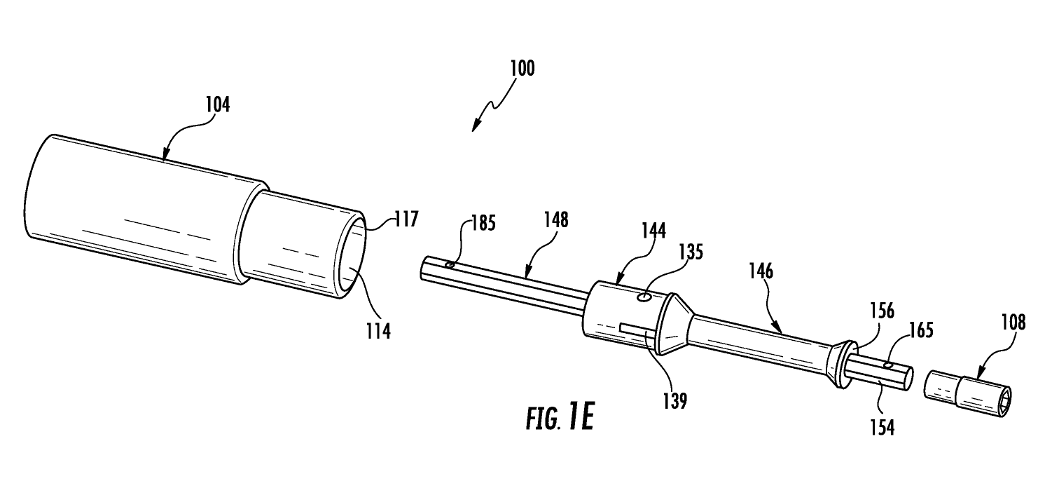

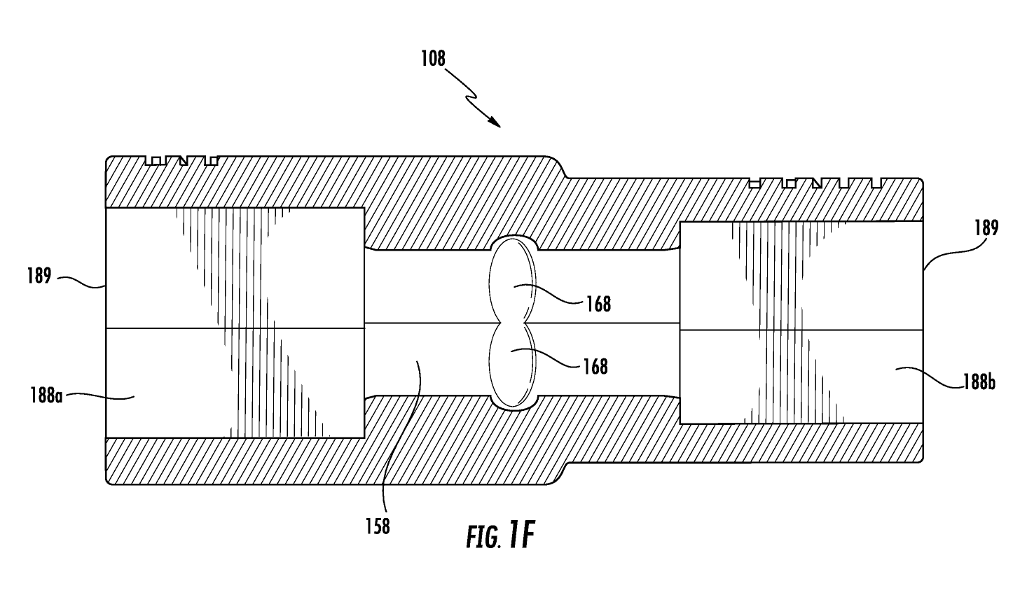

FIGS. 1A-1F illustrate a multi-driver tool 100 (which also may be referred to as a “multi-nut-driver tool” or a “nut-driver tool”) in accordance with one or more example embodiments of the disclosure. The multi-driver tool 100 may be used in various applications to drive nuts and/or other types of fasteners. As described below, the multi-driver tool 100 may include a handle, a shaft removably attached to the handle, and a number of heads each removably attached to the shaft. The multi-driver tool 100 may have an assembled configuration for driving a fastener with one of the heads, in which the shaft is attached to and positioned partially within the handle, one of the heads is attached to the shaft and positioned entirely outside of the handle, and one or more of the heads is attached to the shaft and positioned entirely within the handle. In this manner, when the multi-driver tool 100 is in the assembled configuration, the one of the heads may be used to drive a fastener, while the one or more of the heads may be stored and protected within the handle. The multi-driver tool 100 also may have a disassembled configuration for changing out the head to be used to drive a fastener, in which the shaft is detached from and positioned entirely outside of the handle. In this manner, when the multi-driver tool 100 is in the disassembled position, a user may detach two or more of the heads from the shaft and reattach the heads to the shaft in different positions, with a desired one of the heads in position to drive a fastener.

As compared to certain conventional multi-driver tools, embodiments of the multi-driver tool 100 may provide a compact and convenient configuration for securely storing and protecting multiple heads within the handle of the tool 100, may allow a user to change out the heads of the tool 100 in a straightforward and efficient manner, may allow a user to grasp the handle of the tool 100 in an ergonomic manner with the user's driving hand without disturbing the heads of the tool 100, may allow a user to grasp the shaft of the tool 100 in an ergonomic manner with the user's supporting hand without disturbing the heads of the tool 100, may allow a user to easily visualize a head attached to a working end of the shaft of the tool 100 and engage a fastener with the head, may avoid the need for an undesirably bulky handle of the tool 100, and/or may allow a user to store commonly-used heads of the tool 100 in an easily accessible position.

The multi-driver tool 100 may be formed as an elongated assembly having a longitudinal axis A_{L}, a proximal end 101 (which also may be referred to as a “user end” or a “first end”), and a distal end 102 (which also may be referred to as a “working end” or a “second end”). As shown in FIGS. 1A-1F, the multi-driver tool 100 may include a handle 104 (which also may be referred to as a “handle assembly”), a shaft 106 (which also may be referred to as a “shaft assembly”) attached to the handle 104, and a number of heads 108 (which also may be referred to individually as a “head assembly,” a “fastener-driving head,” a “socket,” or a “socket assembly”) attached to the shaft 106. In particular, the shaft 106 may be removably attached to the handle 104, and each of the heads 108 may be removably attached to the shaft 106, as described in detail below.

The multi-driver tool 100 may have an assembled configuration (which also may be referred to as a “driving configuration”), such as the configuration shown in FIGS. 1A and 1B, for driving a fastener with one of the heads 108. When the multi-driver tool 100 is in the assembled configuration, the shaft 106 may be attached to and positioned partially within the handle 104, one of the heads 108 may be attached to the shaft 106 and positioned entirely outside of the handle 104 (which may be referred to as a “driving position”), and one or more of the heads 108 may be attached to the shaft 106 and positioned entirely within the handle 104 (which may be referred to as a “storage position”), as shown. In this manner, the head 108 in the driving position may be used to drive a fastener, while the one or more heads 108 in the storage position may be stored and protected within the handle 104. In certain example embodiments, as shown, when the multi-driver tool 100 is in the assembled configuration, respective longitudinal axes of the handle 104, the shaft 106, and each of the heads 108 may be coaxial with one another and coaxial with the longitudinal axis A_{L} of the tool 100. The multi-driver tool 100 also may have a disassembled configuration (which also may be referred to as a “change-out configuration”), such as the configuration shown in FIG. 1D, for changing out the head 108 in the driving position. When the multi-driver tool 100 is in the disassembled configuration, the shaft 106 may be detached from and positioned entirely outside of the handle 104, as shown. In this manner, when the multi-driver tool 100 is in the disassembled configuration, a user may detach two or more of the heads 108 from the shaft 106 and reattach the heads 108 to the shaft 106 in different positions. Following reattachment of the heads 108 to the shaft 106, the user may reattach the shaft 106 to the handle 104, with a desired one of the heads 108 in the driving position and the other heads 108 in the storage position, such that the multi-driver tool 100 is again in the assembled configuration for driving a fastener.

As shown in FIGS. 1A and 1B, the handle 104 may be formed as an elongated member or assembly having a generally cylindrical shape that is sized and configured to fit comfortably in the hand of a user. The handle 104 may have a longitudinal axis, a proximal end 111 (which also may be referred to as a “first end”), and a distal end 112 (which also may be referred to as a “second end”). The handle 104 may include and define an internal cavity 114 extending along the longitudinal axis of the handle 104. As described below, the internal cavity 114 may be configured to removably receive a portion of the shaft 106 and one or more of the heads 108 therein. As shown, the handle 104 may include a circumferential wall 115 extending about and spaced apart from the longitudinal axis of the handle 104, an end wall 116 (which also may be referred to as a “proximal end wall”) positioned at the proximal end 111 of the handle 104, and an opening 117 (which also may be referred to as a “distal opening”) defined in the distal end 112 of the handle 104 and in communication with the internal cavity 114. In this manner, the internal cavity 114 may be defined by the internal surfaces of the circumferential wall 115 and the end wall 116, the proximal end 111 of the handle 104 may be closed, and the distal end 112 of the handle 104 may be open such that the internal cavity 114 is accessible through the opening 117. In certain example embodiments, as shown, the internal cavity 114 may have a generally cylindrical shape, although other shapes of the internal cavity 114 may be used in other example embodiments. In certain example embodiments, the handle 104 may include a metal slug 118 positioned within the internal cavity 114 at the proximal end of the cavity 114 adjacent the end wall 116. In this manner, the metal slug 118 may protect the end wall 116 of the handle 104 from being impacted by heads 108 that are not fully seated on the shaft 106 when the shaft 106 is inserted into the internal cavity 114. The metal slug 118 may be particularly beneficial in embodiments in which the end wall 116 of the handle 104 is formed of a relatively soft material, such as plastic. The metal slug 118 may be insert molded into the handle 104 or may be inserted into the internal cavity 114 and secured in place by a separate attachment mechanism, such as an adhesive, a fastener, or the like. In certain example embodiments, such as embodiments in which the end wall 116 is formed of metal, the metal slug 118 may be omitted.

In certain example embodiments, the handle 104 may include a rigid core and a grip positioned over at least a portion of the rigid core and fixedly attached thereto. In this manner, the rigid core may provide structural integrity to the handle 104, and the grip may allow a user to securely grasp and manipulate the handle 104. In certain example embodiments, the grip may include an elastomer layer having a soft grip surface which may allow a user to easily grasp and manipulate the handle 104. In certain example embodiments, one or more of the external surfaces of the handle 104, such as the external surfaces of the rigid core and/or the grip, may include a geometry configured to facilitate manipulation of the handle 104 by a user. For example, one or more of the external surfaces of the handle 104 may include a textured surface, which may allow a user to easily grasp and manipulate the handle 104. The textured surface may include a number of grooves, ribs, protrusions, or other texturing features or patterns to facilitate gripping of the handle 104 by a user. In certain example embodiments, the textured surface or the soft grip surface of the handle 104 may be provided by forming an elastomer layer of the grip over the rigid core of the handle 104. For example, the elastomer layer may be overmolded on the rigid core. The handle 104, or at least the rigid core thereof, may be formed of any suitably strong, rigid material, such as metal, plastic or the like, or combinations of such materials. In certain example embodiments, the rigid core may be formed of a rigid cellulose acetate or polycarbonate, and the grip may be formed of a thermoplastic rubber (TPR) and polypropylene, although other suitable materials may be used for the rigid core and the grip in other example embodiments.

In certain example embodiments, the handle 104 may include a number of flat external surfaces that may be conveniently engaged and gripped by a separate tool, such as a wrench, pliers or the like. For example, the flat external surfaces of the handle 104 may form a square or hexagonal shape along the external circumference of the handle 104, which may be conveniently engaged and gripped by the separate tool. In some example embodiments, the handle 104 may include a receptacle defined in the proximal end 111 of the handle 104, such as in the end wall 116, and configured to receive a male end of a turning tool, such as a ratchet wrench. The receptacle may have a square or hexagonal shape, although other shapes of the receptacle may be used. In some example embodiments, the handle 104 may have a shape other than the generally cylindrical shape shown in the illustrated embodiment. For example, the handle 104 may have a T-shape, with laterally extending wings that extend outward from the circumferential wall 115 of the handle 104 and are configured to be gripped by a user to increase the torque applied to the multi-driver tool 100. The laterally extending wings may be movable, such as pivotable, relative to the circumferential wall 115 of the handle 104. In this manner, the wings may be deployed to extend from the circumferential wall 115 when the wings are in use and may be positioned against the circumferential wall 115 when the wings are not in use. It will be understood that the handle 104 may have a variety of shapes, sizes, and configurations in addition to those shown in the figures and described herein.

In certain example embodiments, the multi-driver tool 100 may include an insert bolster 120 attached to the handle 104 and positioned within the internal cavity 114 of the handle 104 adjacent the opening 117. As described below, the insert bolster 120 may be configured to provide a connection point for attaching the shaft 106 to the handle 104. As shown in FIGS. 1B and 1C, the insert bolster 120 may be formed as an elongated member or assembly having a generally cylindrical and tubular shape that is sized and configured to be positioned within the internal cavity 114. The insert bolster 120 may have a longitudinal axis, a proximal end 121 (which also may be referred to as a “first end”), and a distal end 122 (which also may be referred to as a “second end”). The insert bolster 120 may include and define an internal bore 124 extending along the longitudinal axis of the insert bolster 120 from a proximal opening 125 defined in the proximal end 121 of the insert bolster 120 to a distal opening 126 defined in the distal end 122 of the insert bolster 120. The insert bolster 120 may be secured within the internal cavity 114 such that the insert bolster 120 is fixedly attached to and rotates with the handle 104. In this manner, the handle 104 and the insert bolster 120 may form a mechanically integrated assembly.

The insert bolster 120 may be fixedly attached to the handle 104 by a variety of connection mechanisms. In certain example embodiments, the insert bolster 120 may include a groove 127 (which also may be referred to as a “circumferential groove”) defined in the external circumferential surface of the insert bolster 120, as shown in FIGS. 1B and 1C. The groove 127 may receive a mating projection 128 formed on the internal circumferential surface of the handle 104, as shown in FIG. 1B, such that the insert bolster 120 is axially fixed relative to the handle 104. In certain example embodiments, as shown, the projection 128 may have an annular shape extending along the entire internal circumferential surface of the handle 104. According to certain example embodiments in which the handle 104 is formed of plastic, the insert bolster 120 may be ultrasonically sealed to the handle 104 during manufacturing to permanently secure the insert bolster 120 to the handle 104. The ultrasonic process may involve melting the plastic of the handle 104 into the groove 127 to provide a permanent connection between the insert bolster 120 and the handle 104. In certain example embodiments, the insert bolster 120 may include a number of splines 131 (which also may be referred to as “linear ribs”) defined along the external circumferential surface of the insert bolster 120 and extending longitudinally along the insert bolster 120, as shown in FIG. 1C. The splines 131 of the insert bolster 120 may engage a number of splines 132 (which also may be referred to as “linear ribs”) defined along the internal circumferential surface of the handle 104 and extending longitudinally along the handle 104, such that the insert bolster 120 is prevented from rotating relative to the handle 104 about the longitudinal axis A_{L} of the multi-driver tool 100. In this manner, the insert bolster 120 may rotate with the handle 104 during use of the tool 100. In certain example embodiments, the insert bolster 120 may be formed of plated cast zinc. In certain example embodiments, the insert bolster 120 may be fixedly attached to the handle 104 by one or more fasteners, one or more adhesives, welding, or combinations of connection mechanisms. It will be understood that the insert bolster 120 may have a variety of shapes, sizes, and configurations in addition to those shown in the figures and described herein. In certain example embodiments, the insert bolster 120 may be omitted, and the features of the insert bolster 120 may be formed integrally with the handle 104 along the internal circumferential surface of the handle 104. In this manner, the handle 104 may provide the functionality of the insert bolster 120 described herein.

As shown in FIG. 1B, the insert bolster 120 may be configured to removably attach the shaft 106 to the handle 104. The insert bolster 120 may include a receptacle 134 (which also may be referred to as a “ball receptacle”) defined therein and configured to receive and releasably engage a ball 135 of the shaft 106 to retain a portion of the shaft 106 within the handle 104. The receptacle 134 may be formed as a hole defined in the insert bolster 120 and extending from the internal circumferential surface to the external circumferential surface of the insert bolster 120, as shown. Alternatively, the receptacle 134 may be formed as a detent defined in the internal circumferential surface of the insert bolster 120. The receptacle 134 of the insert bolster 120 may be sized and configured to receive the ball 135 of the shaft 106 in a snap-fit connection. In certain example embodiments, as shown, the ball 135 of the shaft 106 may be biased away from the longitudinal axis of the shaft 106 and toward the receptacle 134 of the insert bolster 120 by a spring 136 of the shaft 106 to facilitate the snap-fit connection. In certain example embodiments, the configuration of the receptacle 134 and the ball 135 may be reversed such that the receptacle 134 is defined in the shaft 106 and the ball 135 is positioned along the internal circumferential surface of the insert bolster 120. In certain example embodiments, the insert bolster 120 may be omitted, and the receptacle 134 may be defined in the internal circumferential surface of the handle 104 or the ball 135 may be positioned along the internal circumferential surface of the handle 104.

As shown in FIG. 1C, the insert bolster 120 may include one or more receptacles 138 (which also may be referred to as “female receptacles” or “projection receptacles”) defined in the internal circumferential surface of the insert bolster 120 and configured to receive one or more projections 139 (which also may be referred to as “male projections” or “ears”) of the shaft 106. The receptacles 138 of the insert bolster 120 may extend longitudinally along the insert bolster 120, and the projections 139 may extend longitudinally along the shaft 106, as shown. When the projections 139 are received within the receptacles 138, the connection between the receptacles 138 and the projections 139 may prevent rotation of the shaft 106 relative to the insert bolster 120 and the handle 104. In this manner, the connection between the receptacles 138 and the projections 139 may provide a torque coupling between the shaft 106 and the insert bolster 120 and the handle 104, such that torque applied to the handle 104 by a user is transmitted to the shaft 106. In certain example embodiments, the configuration of the receptacles 138 and the projections 139 may be reversed such that the receptacles 138 are defined in the shaft 106 and the projections 139 are positioned along the internal circumferential surface of the insert bolster 120. In certain example embodiments, the insert bolster 120 may be omitted, and the receptacles 138 may be defined in the internal circumferential surface of the handle 104 or the projections 139 may be positioned along the internal circumferential surface of the handle 104. It will be understood that the insert bolster 120 may have a variety of shapes, sizes, and configurations in addition to those shown in the figures and described herein.

As shown in FIGS. 1A-1E, the shaft 106 may be formed as an elongated member or assembly having a longitudinal axis, a proximal end 141 (which also may be referred to as a “first end”), and a distal end 142 (which also may be referred to as a “second end”). The shaft 106 may include an interface section 144 (which also may be referred to as an “interface portion”), a working section 146 (which also may be referred to as a “working portion”), and a holder section 148 (which also may be referred to as a “holder portion”). The interface section 144, the working section 146, and the holder section 148 each may have an elongated shape extending along the longitudinal axis of the shaft 106. In certain example embodiments, the interface section 144, the working section 146, and the holder section 148 may be integrally formed with one another. In other example embodiments, portions of the interface section 144, the working section 146, and the holder section 148 may be separately formed and fixedly attached to one another to form the shaft 106. In certain example embodiments, the shaft 106 may be formed of steel, such as nickel chrome plated steel or Cr—V steel (SAE 6150), although other suitable materials may be used for the shaft 106.

As shown, the interface section 144 of the shaft 106 may be positioned generally at the longitudinal center of the shaft 106, although the interface section 144 does not have to be positioned at the exact longitudinal center of the shaft 106, depending on the relative lengths of the working section 146 and the holder section 148. The interface section 144 may include a receptacle 152 (which also may be referred to as a “ball receptacle” or a “ball and spring receptacle”) defined therein and extending radially with respect to the longitudinal axis of the shaft 106. In certain example embodiments, as shown, the receptacle 152 may be formed as a blind hole extending from an internal portion of the interface section 144 to the external circumferential surface of the interface section 144. As shown, the ball 135 and the spring 136 of the shaft 106 may be positioned within the receptacle 152 of the interface section 144 such that the spring 136 biases the ball 135 away from the longitudinal axis of the shaft 106. The interface section 144 also may include the projections 139 extending longitudinally along the external circumferential surface of the interface section 144 and configured to engage the receptacles 138 of the insert bolster 120 or the handle 104. The interface section 144 may be sized and configured to be relatively closely received within the internal bore 124 of the insert bolster 120 or within the internal cavity 114 of the handle 104 according to embodiments in which the insert bolster 120 is omitted.

When the multi-driver tool 100 is in the assembled configuration, the interface section 144 of the shaft 106 may be at least partially or entirely received within the handle 104. Further, when the multi-driver tool 100 is in the assembled configuration, the engagement features of interface section 144, such as the ball 135 and the projections 139, may engage the engagement features of the insert bolster 120 (or the handle 104 according to embodiments in which the insert bolster 120 is omitted), such as the receptacle 134 and the receptacles 138. In this manner, when the multi-driver tool 100 is in the assembled configuration, the shaft 106 may be removably attached to the handle 104 and relative rotation between the handle 104 and the shaft 106 may be prevented. In certain example embodiments, as shown, the external circumferential surface of the interface section 144 and the internal circumferential surface of the insert bolster 120 (or the handle 104 according to embodiments in which the insert bolster 120 is omitted) may have mating cylindrical shapes, and the interface section 144 may include the projections 139. In other example embodiments, the external circumferential surface of the interface section 144 and the internal circumferential surface of the insert bolster 120 (or the handle 104 according to embodiments in which the insert bolster 120 is omitted) may have other mating cross-sectional shapes, such as a square shape or a hexagonal shape, which prevent relative rotation between the handle 104 and the shaft 106, such that the projections 139 may be omitted from the interface section 144 and the receptacles 138 of the insert bolster 120 (or the handle 104 according to embodiments in which the insert bolster 120 is omitted) may be omitted.

As shown, the working section 146 of the shaft 106 may be formed as a rod-like member and may be positioned distally with respect to the interface section 144. In particular, the working section 146 may extend longitudinally from the distal end of the interface section 144 to the distal end 142 of the shaft 106. The working section 146 may include a head connector 154 (which also may be referred to as a “head driving connector” or a “head projection”) positioned at the distal end of the working section 146 and configured to removably attach one of the heads 108 to the shaft 106. As shown, the cross-section of the head connector 154 may be relatively small such that the head connector 154 may interface with a relatively small head 108, while the cross-section of the remainder of the working section 146 may be larger in order to accommodate high torques, shaft bending loads, and chiseling loads applied by a user to the multi-driver tool 100. In certain example embodiments, the head connector 154 may have a width of approximately 6 mm, approximately ¼ inch, or approximately 5/16 inch to accommodate a relatively small head 108, such as a head 108 having a 6 mm socket, a ¼ inch socket, or a 5/16 inch socket, respectively, although other widths of the head connector 154 may be used in other example embodiments. The working section 146 also may include an abutment surface 156 positioned at the proximal end of the head connector 154 and configured to abut one end of the head 108 when the head 108 is attached to the head connector 154. The abutment surface 156 may be defined by an enlarged annular flange 157 of the working section 146, which limits the distance that the head connector 154 may be inserted into the head 108.

The head connector 154 of the working section 146 may be configured to removably attach each of the heads 108 to the shaft 106, such that heads 108 having different sizes and configurations may be attached to the shaft 106 for driving a fastener. In particular, the head connector 154 may be configured to be received within a mating shaft interface 158 (which also may be referred to as a “shaft receptacle”) of each of the heads 108. As shown, the head connector 154 may have a cross-sectional shape that corresponds to a cross-sectional shape of the shaft interface 158 of the head 108. In certain example embodiments, as shown, the head connector 154 may have a hexagonal cross-sectional shape, and the shaft interface 158 may have a corresponding hexagonal cross-sectional shape, although other suitable cross-sectional shapes of the head connector 154 and the shaft interface 158 may be used in other example embodiments. As shown, the head connector 154 of the working section 146 may include a receptacle 162 (which also may be referred to as a “ball receptacle” or a “ball and spring receptacle”) defined therein and extending radially with respect to the longitudinal axis of the shaft 106. In certain example embodiments, as shown, the receptacle 162 may be formed as a blind hole extending from an internal portion of the head connector 154 to the external circumferential surface of the head connector 154. As shown, a ball 165 and a spring 166 of the head connector 154 may be positioned within the receptacle 162 such that the spring 166 biases the ball 165 away from the longitudinal axis of the shaft 106. The ball 165 may be configured to be received within and releasably engage a receptacle 168 (which also may be referred to as a “ball receptacle”) defined in the shaft interface 158 of the head 108 to retain the head 108 on the head connector 154. In this manner, the head 108 may be removably attached to the head connector 154 of the shaft 106. The receptacle 168 may be formed as a detent defined in the internal circumferential surface of the shaft interface 158. Alternatively, the receptacle 168 may be formed as a hole defined in the head 108 and extending from the internal circumferential surface of the shaft interface 158 to or toward the external circumferential surface of the head 108. The receptacle 168 of the head 108 may be sized and configured to receive the ball 165 of the head connector 154 in a snap-fit connection. As shown, the ball 165 may be positioned on the head connector 154 such that the ball 165 is disposed opposite the receptacle 168 of the head 108 when the head connector 154 is received within the shaft interface 158 and one of the ends of the head 108 abuts the abutment surface 156 of the working section 146. In certain example embodiments, the configuration of the receptacle 168 and the ball 165 may be reversed such that the receptacle 168 is defined in the head connector 154 and the ball 165 is positioned along the internal circumferential surface of the shaft interface 158 of the head 108. However, it may be less expensive to provide the ball 165 and the spring 166 on the head connector 154 than to provide the ball 165 and the spring 166 on the head 108.

As shown, the holder section 148 of the shaft 106 may be formed as a rod-like member and may be positioned proximally with respect to the interface section 144. In particular, the holder section 148 may extend longitudinally from the proximal end of the interface section 144 to the proximal end 141 of the shaft 104. The holder section 148 may include a head connector 174 (which also may be referred to as a “head storage connector” or a “head projection”) positioned at the proximal end of the holder section 148 and configured to removably attach one or more of the heads 108 to the shaft 106. As shown, the cross-section of the head connector 174 may be relatively small such that the head connector 174 may interface with a relatively small head 108. In certain example embodiments, the head connector 174 may have a width of approximately 6 mm, approximately ¼ inch, or approximately 5/16 inch to accommodate a relatively small head 108, such as a head 108 having a 6 mm socket, a ¼ inch socket, or a 5/16 inch socket, respectively, although other widths of the head connector 174 may be used in other example embodiments.

The head connector 174 of the holder section 148 may be configured to removably attach each of the heads 108 to the shaft 106, such that heads 108 having different sizes and configurations may be attached to the shaft 106 and stored within the handle 104. In particular, the head connector 174 may be configured to be received within the mating shaft interface 158 of each of the heads 108. As shown, the head connector 174 may have a cross-sectional shape that corresponds to a cross-sectional shape of the shaft interface 158 of the head 108. In certain example embodiments, as shown, the head connector 174 may have a hexagonal cross-sectional shape, and the shaft interface 158 may have a corresponding hexagonal cross-sectional shape, although other suitable cross-sectional shapes of the head connector 174 and the shaft interface 158 may be used in other example embodiments. As shown, the entire length of the head connector 174 or substantially the entire length of the head connector 174 may be sized and configured to be received within the mating shaft interfaces 158 of the heads 108, such that the heads 108 may be slid over the entire length or substantially the entire length of the head connector 174 and the holder section 148. The head connector 174 of the holder section 148 and the internal cavity 114 of the handle 104 may be sized and configured to allow two or more of the heads 108 to be removably attached to the head connector 174 and positioned within the handle 104 when the multi-driver tool 100 is in the assembled configuration, as shown in FIG. 1B. Although the illustrated embodiment shows two heads 108 attached to the head connector 174 and positioned within the handle 104, it will be appreciated that the head connector 174 and the internal cavity 114 may be sized and configured to accommodate any number of heads 108 in other example embodiments.

As shown, the head connector 174 of the holder section 148 may include a receptacle 182 (which also may be referred to as a “ball receptacle” or a “ball and spring receptacle”) defined therein and extending radially with respect to the longitudinal axis of the shaft 106. In certain example embodiments, as shown, the receptacle 182 may be formed as a blind hole extending from an internal portion of the head connector 174 to the external circumferential surface of the head connector 174. As shown, a ball 185 and a spring 186 of the head connector 174 may be positioned within the receptacle 182 such that the spring 186 biases the ball 185 away from the longitudinal axis of the shaft 106. The ball 185 may be configured to be received within and releasably engage the receptacle 168 defined in the shaft interface 158 of the head 108 to retain the head 108 on the head connector 174. In this manner, the head 108 may be removably attached to the head connector 174 of the shaft 106. The receptacle 168 of the head 108 may be sized and configured to receive the ball 185 of the head connector 174 in a snap-fit connection. As shown, the ball 185 may be positioned on the head connector 174 such that the ball 185 is disposed opposite the receptacle 168 of the proximal-most head 108 when the head connector 174 is received within the shaft interface 158 of the proximal-most head 108. In this manner, the engagement between the ball 185 and the proximal-most head 108 may hold any and all of the other heads 108 attached to the head connector 174 on the shaft 106. In certain example embodiments, the head connector 174 may include a number of receptacles 182, balls 185, and springs 186, such that each of the heads 108 attached to the head connector 174 is releasably engaged by one of the balls 185 and independently held on the shaft 106 thereby. In certain example embodiments, the configuration of the receptacle 182 and the ball 185 may be reversed such that the receptacle 182 is defined in the head connector 174 and the ball 185 is positioned along the internal circumferential surface of the shaft interface 158 of the head 108. However, it may be less expensive to provide the ball 185 and the spring 186 on the head connector 174 than to provide the ball 185 and the spring 186 on the head 108.

Each head 108 of the multi-driver tool 100 may be formed as an elongated member or assembly having a generally cylindrical and tubular shape that is sized and configured to be positioned on the head connector 154 of the working section 162 of the shaft 106, on the holder section 148 of the shaft 106, and within the internal cavity 114 of the handle 104. As shown, each head 108 may include two sockets 188 defined therein. In particular, each head 108 may include a first socket 188a defined in a first end of the head 108 and extending to the shaft interface 158 of the head 108, and a second socket 188b defined in the second end of the head 108 and extending to the shaft interface 158 of the head 108. In this manner, the shaft interface 158 may be positioned longitudinally between the first socket 188a and the second socket 188b, such that the shaft interface 158 and the sockets 188a, 188b collectively form an internal cavity that extends from the first end to the second end of the head 108. As shown, the first socket 188a may have a different size than the second socket 188b. In some example embodiments, the first socket 188a also may have a different configuration than the second socket 188b. In this manner, each head 108 may be reversible and configured to engage and drive two different fasteners of different sizes and/or configurations. The sockets 188a, 188b generally may be configured in a manner similar to conventional sockets. In certain example embodiments, as shown in FIG. 1F, each of the sockets 188a, 188b may include a zero-chamfer lead-in surface 189, such that the corner between the internal sidewall of the socket 188a, 188b and the corresponding end wall of the head 108 is oriented at a right angle or a substantially right angle. In contrast to conventional sockets that include a chamfered lead-in surface, the zero-chamfer lead-in surfaces 189 of the sockets 188a, 188b may allow the sockets 188a, 188b to better engage low-profile fasteners, such as sheet metal screws. In particular, the zero-chamfer lead-in surfaces 189 of the sockets 188a, 188b may ensure that the full face of the fastener is engaged by the internal sidewalls of the sockets 188a, 188b. Each of the sockets 188a, 188b may be sized and configured to engage standard size fasteners and may be sized in the same or different units. In certain example embodiments, the heads 108 may be formed of forged nickel plated steel, although other suitable materials may be used in other example embodiments.

As shown, the head connector 154 of the working section 146 of the shaft 106 may be sized and configured to be inserted into each of the heads 108 through either the first end or the second end of the head 108. In this manner, each of the heads 108 may be attached to the head connector 154 by inserting the head connector 154 through the first socket 188a and engaging the shaft interface 158 of the head 108 with the head connector 154 or by inserting the head connector 154 through the second socket 188b and engaging the shaft interface 158 of the head 108 with the head connector 154. When one of the heads 108 is attached to the head connector 154, the head connector 154 may engage the shaft interface 158 such that the head connector 154 and the head 108 rotate together during use of the multi-driver tool 100. In certain example embodiments, as shown in FIG. 1B, when one of the heads 108 is attached to the head connector 154, the distal end of the head connector 154 may be positioned at the internal end of the exposed socket 188a, 188b or proximally with respect to the internal end of the exposed socket 188a, 188b, such that the exposed socket 188a, 188b is free to receive a fastener therein. In other example embodiments, when one of the heads 108 is attached to the head connector 154, the distal end of the head connector 154 may be positioned within the exposed socket 188a, 188b. In certain example embodiments, when one of the heads 108 is attached to the head connector 154, the distal end of the head connector 154 may effectively form a portion of the internal end of the exposed socket 188a, 188b. In certain example embodiments, as shown, the head connector 154 may include a magnet 191 positioned at the distal end of the head connector 154 and configured to releasably retain a fastener at least partially within the exposed socket 188a, 188b.

As shown in FIG. 1B, a plurality of the heads 108 may be attached to the shaft 106 during use of the multi-driver tool 100. In particular, one or more of the heads 108 may be attached to the holder section 148 of the shaft 106 and stored within the internal cavity 114 of the handle 104, and one of the heads 108 may be attached to the working section 146 of the shaft 106 and “stored” thereon or used to drive a fastener. According to the illustrated embodiment, the multi-driver tool 100 includes three heads 108, with two of the heads 108 attached to the holder section 148 and stored within the internal cavity 114 and one of the heads 108 attached to the working section 146. It will be appreciated that use of a longer handle 104 including a longer internal cavity 114 and/or use of shorter heads 108 may allow a greater number of heads 108 to be stored within the internal cavity 114 of the handle 104. In certain example embodiments in which deeper sockets 188 are required, a single head 108 may be attached to the holder section 148 and stored within the internal cavity 114. In certain example embodiments in which the heads 108 are reversible, the number of different sockets 188 available to a user is double the number of heads 108 of the multi-driver tool 100. It will be appreciated that the sockets 188 of the heads 108 may differ in size (e.g., 3/16- 9/16 inches, etc.), in units (e.g., Imperial (SAE), metric, etc.), in shape (e.g., hexagonal, square, etc.), or combinations of these or other variables. The multi-driver tool 100 may provide a convenient configuration for storing and accessing a user's most commonly used heads 108. For example, commonly used heads 108 may be attached to the head connector 154 of the working section 146 or to the head connector 174 of the holder section 148 in the proximal-most position. The multi-driver tool 100 may be provided and sold as a kit that includes the handle 104, the shaft 106, and a variety of different heads 108. Alternatively, the handle 104 and the shaft 106 may be provided and sold separately from the heads 108, such that a user may individually select the heads 108 required by the user.

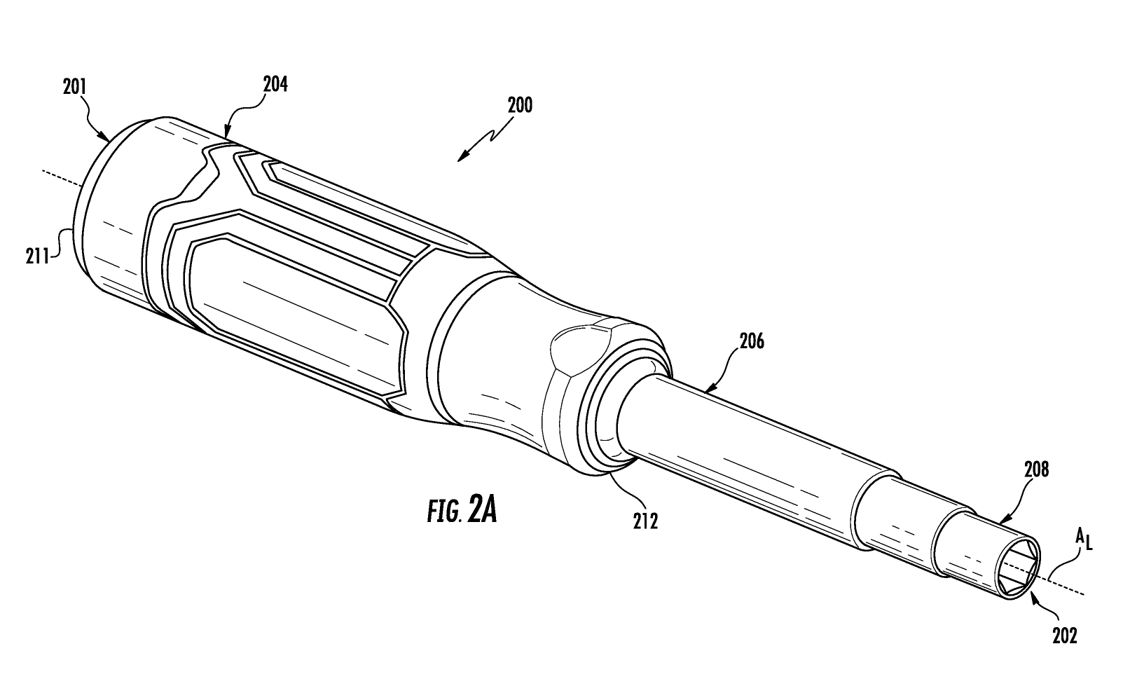

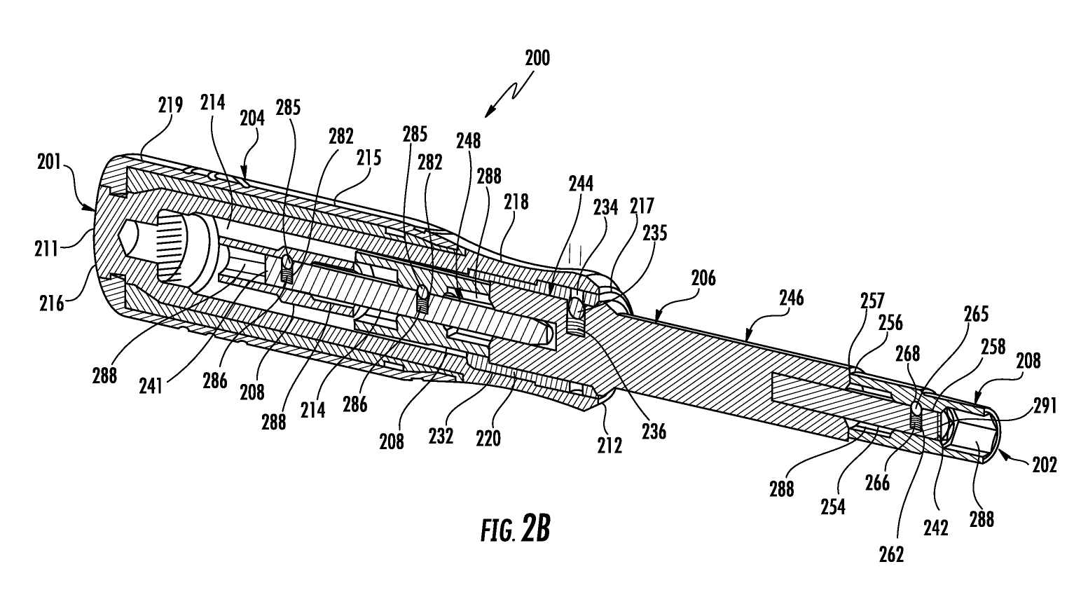

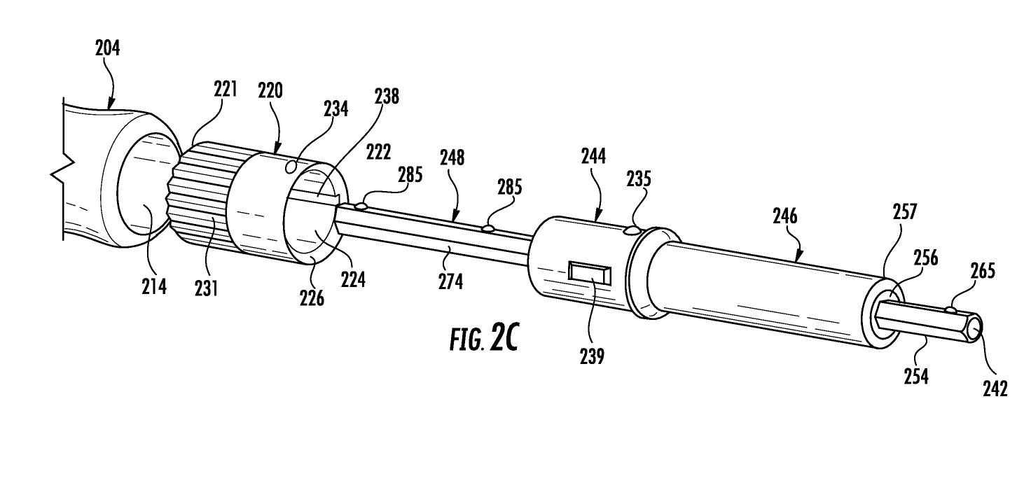

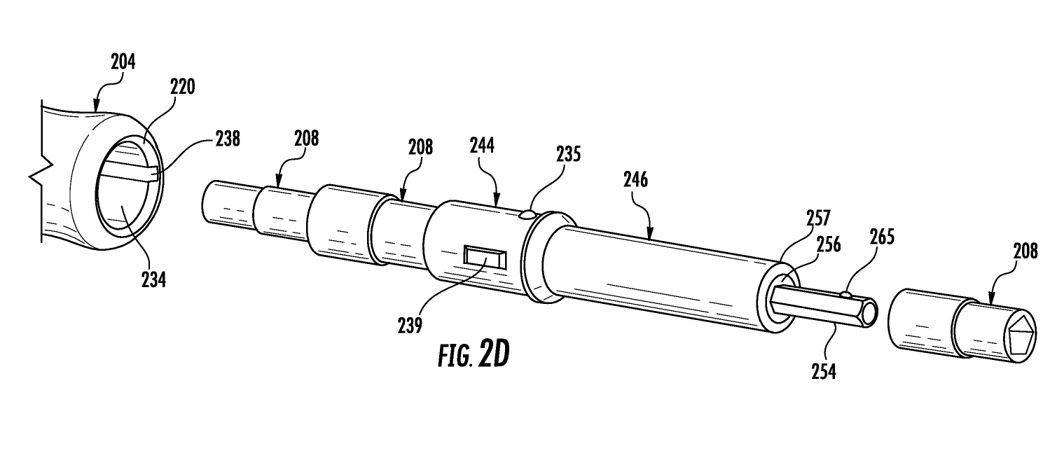

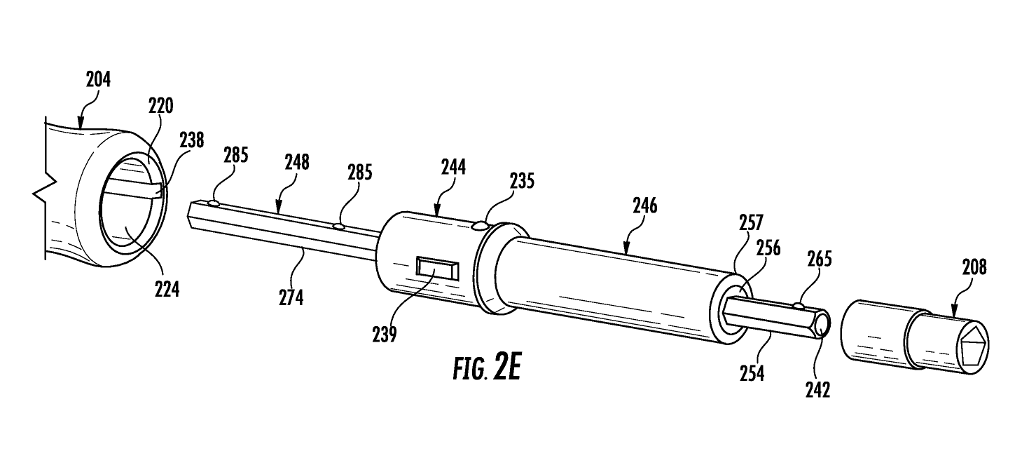

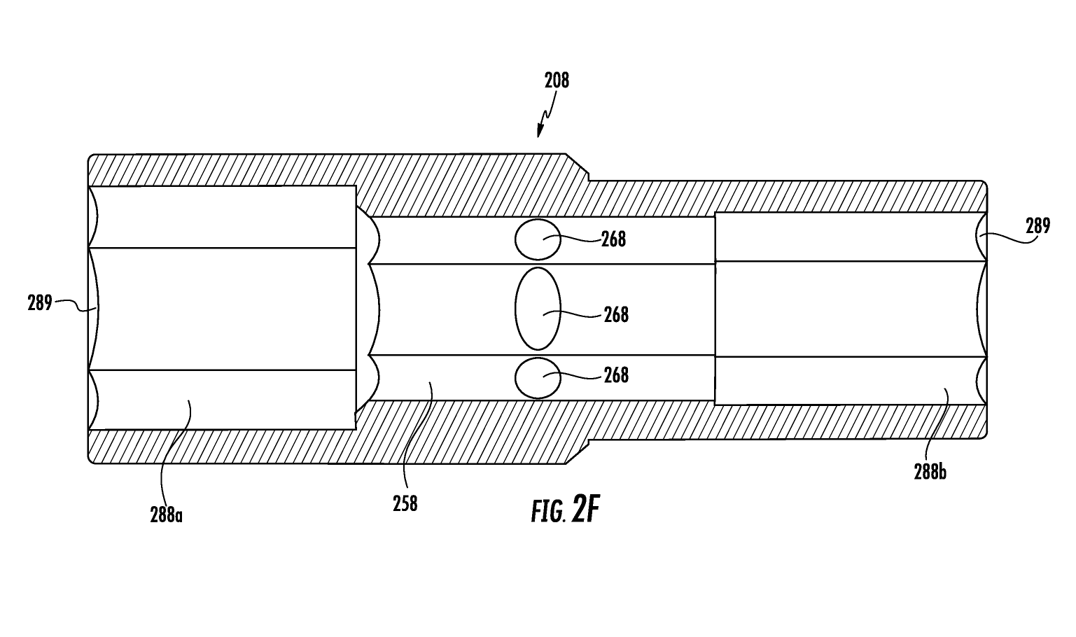

FIGS. 2A-2F illustrate a multi-driver tool 200 (which also may be referred to as a “multi-nut-driver tool” or a “nut-driver tool”) in accordance with one or more example embodiments of the disclosure. The multi-driver tool 200 may be used in various applications to drive nuts and/or other types of fasteners. As described below, the multi-driver tool 200 may include a handle, a shaft removably attached to the handle, and a number of heads each removably attached to the shaft. The multi-driver tool 200 may have an assembled configuration for driving a fastener with one of the heads, in which the shaft is attached to and positioned partially within the handle, one of the heads is attached to the shaft and positioned entirely outside of the handle, and one or more of the heads is attached to the shaft and positioned entirely within the handle. In this manner, when the multi-driver tool 200 is in the assembled configuration, the one of the heads may be used to drive a fastener, while the one or more of the heads may be stored and protected within the handle. The multi-driver tool 200 also may have a disassembled configuration for changing out the head to be used to drive a fastener, in which the shaft is detached from and positioned entirely outside of the handle. In this manner, when the multi-driver tool 200 is in the disassembled position, a user may detach two or more of the heads from the shaft and reattach the heads to the shaft in different positions, with a desired one of the heads in position to drive a fastener.

As compared to certain conventional multi-driver tools, embodiments of the multi-driver tool 200 may provide a compact and convenient configuration for securely storing and protecting multiple heads within the handle of the tool 200, may allow a user to change out the heads of the tool 200 in a straightforward and efficient manner, may allow a user to grasp the handle of the tool 200 in an ergonomic manner with the user's driving hand without disturbing the heads of the tool 200, may allow a user to grasp the shaft of the tool 200 in an ergonomic manner with the user's supporting hand without disturbing the heads of the tool 200, may allow a user to easily visualize a head attached to a working end of the shaft of the tool 200 and engage a fastener with the head, may avoid the need for an undesirably bulky handle of the tool 200, and/or may allow a user to store commonly-used heads of the tool 200 in an easily accessible position.

The multi-driver tool 200 may be formed as an elongated assembly having a longitudinal axis A_{L}, a proximal end 201 (which also may be referred to as a “user end” or a “first end”), and a distal end 202 (which also may be referred to as a “working end” or a “second end”). As shown in FIGS. 2A-2F, the multi-driver tool 200 may include a handle 204 (which also may be referred to as a “handle assembly”), a shaft 206 (which also may be referred to as a “shaft assembly”) attached to the handle 204, and a number of heads 208 (which also may be referred to individually as a “head assembly,” a “fastener-driving head,” a “socket,” or a “socket assembly”) attached to the shaft 206. In particular, the shaft 206 may be removably attached to the handle 204, and each of the heads 208 may be removably attached to the shaft 206, as described in detail below.

The multi-driver tool 200 may have an assembled configuration (which also may be referred to as a “driving configuration”), such as the configuration shown in FIGS. 2A and 2B, for driving a fastener with one of the heads 208. When the multi-driver tool 200 is in the assembled configuration, the shaft 206 may be attached to and positioned partially within the handle 204, one of the heads 208 may be attached to the shaft 206 and positioned entirely outside of the handle 204 (which may be referred to as a “driving position”), and one or more of the heads 208 may be attached to the shaft 206 and positioned entirely within the handle 204 (which may be referred to as a “storage position”), as shown. In this manner, the head 208 in the driving position may be used to drive a fastener, while the one or more heads 208 in the storage position may be stored and protected within the handle 204. In certain example embodiments, as shown, when the multi-driver tool 200 is in the assembled configuration, respective longitudinal axes of the handle 204, the shaft 206, and each of the heads 208 may be coaxial with one another and coaxial with the longitudinal axis A_{L} of the tool 200. The multi-driver tool 200 also may have a disassembled configuration (which also may be referred to as a “change-out configuration”), such as the configuration shown in FIG. 2D, for changing out the head 208 in the driving position. When the multi-driver tool 200 is in the disassembled configuration, the shaft 206 may be detached from and positioned entirely outside of the handle 204, as shown. In this manner, when the multi-driver tool 200 is in the disassembled configuration, a user may detach two or more of the heads 208 from the shaft 206 and reattach the heads 208 to the shaft 206 in different positions. Following reattachment of the heads 208 to the shaft 206, the user may reattach the shaft 206 to the handle 204, with a desired one of the heads 208 in the driving position and the other heads 208 in the storage position, such that the multi-driver tool 200 is again in the assembled configuration for driving a fastener.

As shown in FIGS. 2A and 2B, the handle 204 may be formed as an elongated member or assembly having a generally cylindrical shape that is sized and configured to fit comfortably in the hand of a user. The handle 204 may have a longitudinal axis, a proximal end 211 (which also may be referred to as a “first end”), and a distal end 212 (which also may be referred to as a “second end”). The handle 204 may include and define an internal cavity 214 extending along the longitudinal axis of the handle 204. As described below, the internal cavity 214 may be configured to removably receive a portion of the shaft 206 and one or more of the heads 208 therein. As shown, the handle 204 may include a circumferential wall 215 extending about and spaced apart from the longitudinal axis of the handle 204, an end wall 216 (which also may be referred to as a “proximal end wall”) positioned at the proximal end 211 of the handle 204, and an opening 217 (which also may be referred to as a “distal opening”) defined in the distal end 212 of the handle 204 and in communication with the internal cavity 214. In this manner, the internal cavity 214 may be defined by the internal surfaces of the circumferential wall 215 and the end wall 216, the proximal end 211 of the handle 204 may be closed, and the distal end 212 of the handle 204 may be open such that the internal cavity 214 is accessible through the opening 217. In certain example embodiments, as shown, the internal cavity 214 may have a generally cylindrical shape, although other shapes of the internal cavity 214 may be used in other example embodiments.

In certain example embodiments, the handle 204 may include a rigid core 218 and a grip 219 positioned over at least a portion of the rigid core 218 and fixedly attached thereto. In this manner, the rigid core 218 may provide structural integrity to the handle 204, and the grip 219 may allow a user to securely grasp and manipulate the handle 204. In certain example embodiments, the grip 219 may include an elastomer layer having a soft grip surface which may allow a user to easily grasp and manipulate the handle 204. In certain example embodiments, one or more of the external surfaces of the handle 204, such as the external surfaces of the rigid core 218 and/or the grip 219, may include a geometry configured to facilitate manipulation of the handle 204 by a user. For example, one or more of the external surfaces of the handle 204 may include a textured surface, which may allow a user to easily grasp and manipulate the handle 204. The textured surface may include a number of grooves, ribs, protrusions, or other texturing features or patterns to facilitate gripping of the handle 204 by a user. In certain example embodiments, the textured surface or the soft grip surface of the handle 204 may be provided by forming an elastomer layer or portion of the grip 219 over the rigid core 218 of the handle 204. For example, the elastomer layer or portion may be overmolded on the rigid core 218. The handle 204, or at least the rigid core 218 thereof, may be formed of any suitably strong, rigid material, such as metal, plastic or the like, or combinations of such materials. In certain example embodiments, the rigid core 218 may be formed of a rigid cellulose acetate or polycarbonate, and the grip 219 may be formed of a thermoplastic rubber (TPR) and polypropylene, although other suitable materials may be used for the rigid core 218 and the grip 219 in other example embodiments. In certain example embodiments, the handle 204 may include a metal slug positioned within the internal cavity 214 at the proximal end of the cavity 214 adjacent the end wall 216. In this manner, the metal slug may protect the end wall 216 of the handle 204 from being impacted by heads 208 that are not fully seated on the shaft 206 when the shaft 206 is inserted into the internal cavity 214. The metal slug may be particularly beneficial in embodiments in which the end wall 216 of the handle 204 is formed of a relatively soft material, such as plastic. The metal slug may be insert molded into the handle 204 or may be inserted into the internal cavity 214 and secured in place by a separate attachment mechanism, such as an adhesive, a fastener, or the like. In certain example embodiments, such as embodiments in which the end wall 216 is formed of metal, the metal slug may be omitted.

In certain example embodiments, the handle 204 may include a number of flat external surfaces that may be conveniently engaged and gripped by a separate tool, such as a wrench, pliers or the like. For example, the flat external surfaces of the handle 204 may form a square or hexagonal shape along the external circumference of the handle 204, which may be conveniently engaged and gripped by the separate tool. In some example embodiments, the handle 204 may include a receptacle defined in the proximal end 211 of the handle 204, such as in the end wall 216, and configured to receive a male end of a turning tool, such as a ratchet wrench. The receptacle may have a square or hexagonal shape, although other shapes of the receptacle may be used. In some example embodiments, the handle 204 may have a shape other than the generally cylindrical shape shown in the illustrated embodiment. For example, the handle 204 may have a T-shape, with laterally extending wings that extend outward from the circumferential wall 215 of the handle 204 and are configured to be gripped by a user to increase the torque applied to the multi-driver tool 200. The laterally extending wings may be movable, such as pivotable, relative to the circumferential wall 215 of the handle 204. In this manner, the wings may be deployed to extend from the circumferential wall 215 when the wings are in use and may be positioned against the circumferential wall 215 when the wings are not in use. It will be understood that the handle 204 may have a variety of shapes, sizes, and configurations in addition to those shown in the figures and described herein.

In certain example embodiments, the multi-driver tool 200 may include an insert bolster 220 attached to the handle 204 and positioned within the internal cavity 214 of the handle 204 adjacent the opening 217. As described below, the insert bolster 220 may be configured to provide a connection point for attaching the shaft 206 to the handle 204. As shown in FIGS. 2B and 2C, the insert bolster 220 may be formed as an elongated member or assembly having a generally cylindrical and tubular shape that is sized and configured to be positioned within the internal cavity 214. The insert bolster 220 may have a longitudinal axis, a proximal end 221 (which also may be referred to as a “first end”), and a distal end 222 (which also may be referred to as a “second end”). The insert bolster 220 may include and define an internal bore 224 extending along the longitudinal axis of the insert bolster 220 from a proximal opening 225 defined in the proximal end 221 of the insert bolster 220 to a distal opening 226 defined in the distal end 222 of the insert bolster 220. The insert bolster 220 may be secured within the internal cavity 214 such that the insert bolster 220 is fixedly attached to and rotates with the handle 204. In this manner, the handle 204 and the insert bolster 220 may form a mechanically integrated assembly.

The insert bolster 220 may be fixedly attached to the handle 204 by a variety of connection mechanisms. In certain example embodiments, as shown, the insert bolster 220 may include a number of splines 231 (which also may be referred to as “linear ribs”) defined along the external circumferential surface of the insert bolster 220 and extending longitudinally along the insert bolster 220, as shown in FIG. 2C. The splines 231 of the insert bolster 220 may engage a number of splines 232 (which also may be referred to as “linear ribs”) defined along the internal circumferential surface of the handle 204 and extending longitudinally along the handle 204, such that the insert bolster 220 is prevented from rotating relative to the handle 204 about the longitudinal axis A_{L} of the multi-driver tool 200. In this manner, the insert bolster 220 may rotate with the handle 204 during use of the tool 200. In certain example embodiments, the insert bolster 220 may include a groove (which also may be referred to as a “circumferential groove”) defined in the external circumferential surface of the insert bolster 220. The groove may receive a mating projection formed on the internal circumferential surface of the handle 204 such that the insert bolster 220 is axially fixed relative to the handle 204. In certain example embodiments, the projection may have an annular shape extending along the entire internal circumferential surface of the handle 204. According to certain example embodiments in which the handle 204 is formed of plastic, the insert bolster 220 may be ultrasonically sealed to the handle 204 during manufacturing to permanently secure the insert bolster 220 to the handle 204. The ultrasonic process may involve melting the plastic of the handle 204 into the groove of the insert bolster 220 to provide a permanent connection between the insert bolster 220 and the handle 204. In certain example embodiments, the insert bolster 220 may be formed of plated cast zinc. In certain example embodiments, the insert bolster 220 may be fixedly attached to the handle 204 by one or more fasteners, one or more adhesives, welding, or combinations of connection mechanisms. It will be understood that the insert bolster 220 may have a variety of shapes, sizes, and configurations in addition to those shown in the figures and described herein. In certain example embodiments, the insert bolster 220 may be omitted, and the features of the insert bolster 220 may be formed integrally with the handle 204 along the internal circumferential surface of the handle 204. In this manner, the handle 204 may provide the functionality of the insert bolster 220 described herein.

As shown in FIG. 2B, the insert bolster 220 may be configured to removably attach the shaft 206 to the handle 204. The insert bolster 220 may include a receptacle 234 (which also may be referred to as a “ball receptacle”) defined therein and configured to receive and releasably engage a ball 235 of the shaft 206 to retain a portion of the shaft 206 within the handle 204. The receptacle 234 may be formed as a hole defined in the insert bolster 220 and extending from the internal circumferential surface to the external circumferential surface of the insert bolster 220, as shown. Alternatively, the receptacle 234 may be formed as a detent defined in the internal circumferential surface of the insert bolster 220. The receptacle 234 of the insert bolster 220 may be sized and configured to receive the ball 235 of the shaft 206 in a snap-fit connection. In certain example embodiments, as shown, the ball 235 of the shaft 206 may be biased away from the longitudinal axis of the shaft 206 and toward the receptacle 234 of the insert bolster 220 by a spring 236 of the shaft 206 to facilitate the snap-fit connection. In certain example embodiments, the configuration of the receptacle 234 and the ball 235 may be reversed such that the receptacle 234 is defined in the shaft 206 and the ball 235 is positioned along the internal circumferential surface of the insert bolster 220. In certain example embodiments, the insert bolster 220 may be omitted, and the receptacle 234 may be defined in the internal circumferential surface of the handle 204 or the ball 235 may be positioned along the internal circumferential surface of the handle 204.

As shown in FIG. 2C, the insert bolster 220 may include one or more receptacles 238 (which also may be referred to as “female receptacles” or “projection receptacles”) defined in the internal circumferential surface of the insert bolster 220 and configured to receive one or more projections 239 (which also may be referred to as “male projections” or “ears”) of the shaft 206. The receptacles 238 of the insert bolster 220 may extend longitudinally along the insert bolster 220, and the projections 239 may extend longitudinally along the shaft 206, as shown. When the projections 239 are received within the receptacles 238, the connection between the receptacles 238 and the projections 239 may prevent rotation of the shaft 206 relative to the insert bolster 220 and the handle 204. In this manner, the connection between the receptacles 238 and the projections 239 may provide a torque coupling between the shaft 206 and the insert bolster 220 and the handle 204, such that torque applied to the handle 204 by a user is transmitted to the shaft 206. In certain example embodiments, the configuration of the receptacles 238 and the projections 239 may be reversed such that the receptacles 238 are defined in the shaft 206 and the projections 239 are positioned along the internal circumferential surface of the insert bolster 220. In certain example embodiments, the insert bolster 220 may be omitted, and the receptacles 238 may be defined in the internal circumferential surface of the handle 204 or the projections 239 may be positioned along the internal circumferential surface of the handle 204. It will be understood that the insert bolster 220 may have a variety of shapes, sizes, and configurations in addition to those shown in the figures and described herein.

As shown in FIGS. 2A-2E, the shaft 206 may be formed as an elongated assembly having a longitudinal axis, a proximal end 241 (which also may be referred to as a “first end”), and a distal end 242 (which also may be referred to as a “second end”). The shaft 206 may include an interface section 244 (which also may be referred to as an “interface portion”), a working section 246 (which also may be referred to as a “working portion”), and a holder section 248 (which also may be referred to as a “holder portion”). The interface section 244, the working section 246, and the holder section 248 each may have an elongated shape extending along the longitudinal axis of the shaft 206. In certain example embodiments, as shown, portions of the interface section 244, the working section 246, and the holder section 248 may be separately formed and fixedly attached to one another to form the shaft 206. For example, as shown in FIG. 2B, the interface section 244, the working section 246, and the holder section 248 of the shaft 206 may be formed as a three-part assembly that includes a central portion, a proximal portion, and a distal portion. The proximal portion and the distal portion each may be press fit into the central portion such that the three portions form a mechanically integrated assembly. In other example embodiments, the interface section 244, the working section 246, and the holder section 248 may be integrally formed with one another. In certain example embodiments, the shaft 206 may be formed of steel, such as nickel chrome plated steel or Cr—V steel (SAE 6150), although other suitable materials may be used for the shaft 206.

As shown, the interface section 244 of the shaft 206 may be positioned generally at the longitudinal center of the shaft 206, although the interface section 244 does not have to be positioned at the exact longitudinal center of the shaft 206, depending on the relative lengths of the working section 246 and the holder section 248. The interface section 244 may include a receptacle 252 (which also may be referred to as a “ball receptacle” or a “ball and spring receptacle”) defined therein and extending radially with respect to the longitudinal axis of the shaft 206. In certain example embodiments, as shown, the receptacle 252 may be formed as a blind hole extending from an internal portion of the interface section 244 to the external circumferential surface of the interface section 244. As shown, the ball 235 and the spring 236 of the shaft 206 may be positioned within the receptacle 252 of the interface section 244 such that the spring 236 biases the ball 235 away from the longitudinal axis of the shaft 206. The interface section 244 also may include the projections 239 extending longitudinally along the external circumferential surface of the interface section 244 and configured to engage the receptacles 238 of the insert bolster 220 or the handle 204. The interface section 244 may be sized and configured to be relatively closely received within the internal bore 224 of the insert bolster 220 or within the internal cavity 214 of the handle 204 according to embodiments in which the insert bolster 220 is omitted.

When the multi-driver tool 200 is in the assembled configuration, the interface section 244 of the shaft 206 may be at least partially or entirely received within the handle 204. Further, when the multi-driver tool 200 is in the assembled configuration, the engagement features of interface section 244, such as the ball 235 and the projections 239, may engage the engagement features of the insert bolster 220 (or the handle 204 according to embodiments in which the insert bolster 220 is omitted), such as the receptacle 234 and the receptacles 238. In this manner, when the multi-driver tool 200 is in the assembled configuration, the shaft 206 may be removably attached to the handle 204 and relative rotation between the handle 204 and the shaft 206 may be prevented. In certain example embodiments, as shown, the external circumferential surface of the interface section 244 and the internal circumferential surface of the insert bolster 220 (or the handle 204 according to embodiments in which the insert bolster 220 is omitted) may have mating cylindrical shapes, and the interface section 244 may include the projections 239. In other example embodiments, the external circumferential surface of the interface section 244 and the internal circumferential surface of the insert bolster 220 (or the handle 204 according to embodiments in which the insert bolster 220 is omitted) may have other mating cross-sectional shapes, such as a square shape or a hexagonal shape, which prevent relative rotation between the handle 204 and the shaft 206, such that the projections 239 may be omitted from the interface section 244 and the receptacles 238 of the insert bolster 220 (or the handle 204 according to embodiments in which the insert bolster 220 is omitted) may be omitted.

As shown, the working section 246 of the shaft 206 may be formed as a rod-like member and may be positioned distally with respect to the interface section 244. In particular, the working section 246 may extend longitudinally from the distal end of the interface section 244 to the distal end 242 of the shaft 206. The working section 246 may include a head connector 254 (which also may be referred to as a “head driving connector” or a “head projection”) positioned at the distal end of the working section 246 and configured to removably attach one of the heads 208 to the shaft 206. As shown, the cross-section of the head connector 254 may be relatively small such that the head connector 254 may interface with a relatively small head 208, while the cross-section of the remainder of the working section 246 may be larger in order to accommodate high torques, shaft bending loads, and chiseling loads applied by a user to the multi-driver tool 200. In certain example embodiments, the head connector 254 may have a width of approximately 6 mm, approximately ¼ inch, or approximately 5/16 inch to accommodate a relatively small head 208, such as a head 208 having a 6 mm socket, a ¼ inch socket, or a 5/16 inch socket, respectively, although other widths of the head connector 254 may be used in other example embodiments. The working section 246 also may include an abutment surface 256 positioned at the proximal end of the head connector 254 and configured to abut one end of the head 208 when the head 208 is attached to the head connector 254. The abutment surface 256 may be defined by an enlarged annular flange 257 of the working section 246, which limits the distance that the head connector 254 may be inserted into the head 208.

The head connector 254 of the working section 246 may be configured to removably attach each of the heads 208 to the shaft 206, such that heads 208 having different sizes and configurations may be attached to the shaft 206 for driving a fastener. In particular, the head connector 254 may be configured to be received within a mating shaft interface 258 (which also may be referred to as a “shaft receptacle”) of each of the heads 208. As shown, the head connector 254 may have a cross-sectional shape that corresponds to a cross-sectional shape of the shaft interface 258 of the head 208. In certain example embodiments, as shown, the head connector 254 may have a hexagonal cross-sectional shape, and the shaft interface 258 may have a corresponding hexagonal cross-sectional shape, although other suitable cross-sectional shapes of the head connector 254 and the shaft interface 258 may be used in other example embodiments. As shown, the head connector 254 of the working section 246 may include a receptacle 262 (which also may be referred to as a “ball receptacle” or a “ball and spring receptacle”) defined therein and extending radially with respect to the longitudinal axis of the shaft 206. In certain example embodiments, as shown, the receptacle 262 may be formed as a blind hole extending from an internal portion of the head connector 254 to the external circumferential surface of the head connector 254. As shown, a ball 265 and a spring 266 of the head connector 254 may be positioned within the receptacle 262 such that the spring 266 biases the ball 265 away from the longitudinal axis of the shaft 206. The ball 265 may be configured to be received within and releasably engage a receptacle 268 (which also may be referred to as a “ball receptacle”) defined in the shaft interface 258 of the head 208 to retain the head 208 on the head connector 254. In this manner, the head 208 may be removably attached to the head connector 254 of the shaft 206. The receptacle 268 may be formed as a detent defined in the internal circumferential surface of the shaft interface 258. Alternatively, the receptacle 268 may be formed as a hole defined in the head 208 and extending from the internal circumferential surface of the shaft interface 258 to or toward the external circumferential surface of the head 208. The receptacle 268 of the head 208 may be sized and configured to receive the ball 265 of the head connector 254 in a snap-fit connection. As shown, the ball 265 may be positioned on the head connector 254 such that the ball 265 is disposed opposite the receptacle 268 of the head 208 when the head connector 254 is received within the shaft interface 258 and one of the ends of the head 208 abuts the abutment surface 256 of the working section 246. In certain example embodiments, the configuration of the receptacle 268 and the ball 265 may be reversed such that the receptacle 268 is defined in the head connector 254 and the ball 265 is positioned along the internal circumferential surface of the shaft interface 258 of the head 208. However, it may be less expensive to provide the ball 265 and the spring 266 on the head connector 254 than to provide the ball 265 and the spring 266 on the head 208.

As shown, the holder section 248 of the shaft 206 may be formed as a rod-like member and may be positioned proximally with respect to the interface section 244. In particular, the holder section 248 may extend longitudinally from the proximal end of the interface section 244 to the proximal end 241 of the shaft 204. The holder section 248 may include a head connector 274 (which also may be referred to as a “head storage connector” or a “head projection”) positioned at the proximal end of the holder section 248 and configured to removably attach one or more of the heads 208 to the shaft 206. As shown, the cross-section of the head connector 274 may be relatively small such that the head connector 274 may interface with a relatively small head 208. In certain example embodiments, the head connector 274 may have a width of approximately 6 mm, approximately ¼ inch, or approximately 5/16 inch to accommodate a relatively small head 208, such as a head 208 having a 6 mm socket, a ¼ inch socket, or a 5/16 inch socket, respectively, although other widths of the head connector 274 may be used in other example embodiments.

The head connector 274 of the holder section 248 may be configured to removably attach each of the heads 208 to the shaft 206, such that heads 208 having different sizes and configurations may be attached to the shaft 206 and stored within the handle 204. In particular, the head connector 274 may be configured to be received within the mating shaft interface 258 of each of the heads 208. As shown, the head connector 274 may have a cross-sectional shape that corresponds to a cross-sectional shape of the shaft interface 258 of the head 208. In certain example embodiments, as shown, the head connector 274 may have a hexagonal cross-sectional shape, and the shaft interface 258 may have a corresponding hexagonal cross-sectional shape, although other suitable cross-sectional shapes of the head connector 274 and the shaft interface 258 may be used in other example embodiments. As shown, the entire length of the head connector 274 or substantially the entire length of the head connector 274 may be sized and configured to be received within the mating shaft interfaces 258 of the heads 208, such that the heads 208 may be slid over the entire length or substantially the entire length of the head connector 274 and the holder section 248. The head connector 274 of the holder section 248 and the internal cavity 214 of the handle 204 may be sized and configured to allow two or more of the heads 208 to be removably attached to the head connector 274 and positioned within the handle 204 when the multi-driver tool 200 is in the assembled configuration, as shown in FIG. 2B. Although the illustrated embodiment shows two heads 208 attached to the head connector 274 and positioned within the handle 204, it will be appreciated that the head connector 274 and the internal cavity 214 may be sized and configured to accommodate any number of heads 208 in other example embodiments.

As shown, the head connector 274 of the holder section 248 may include a number of receptacles 282 (which also may be referred to as a “ball receptacles” or a “ball and spring receptacles”) defined therein and extending radially with respect to the longitudinal axis of the shaft 206. In certain example embodiments, as shown, each receptacle 282 may be formed as a blind hole extending from an internal portion of the head connector 274 to the external circumferential surface of the head connector 274. As shown, a ball 285 and a spring 286 of the head connector 274 may be positioned within each receptacle 282 such that the spring 286 biases the ball 285 away from the longitudinal axis of the shaft 206. The ball 285 may be configured to be received within and releasably engage the receptacle 268 defined in the shaft interface 258 of one of the heads 208 to retain the head 208 on the head connector 274. In this manner, the heads 208 may be removably attached to the head connector 274 of the shaft 206. The receptacle 268 of the head 208 may be sized and configured to receive the ball 285 of the head connector 274 in a snap-fit connection. As shown, the receptacles 282 and the balls 285 may be positioned on the head connector 274 such that each ball 285 is disposed opposite the receptacle 168 of a corresponding head 208 when the head connector 274 is received within the shaft interfaces 258 of the heads 208. In this manner, each of the heads 208 attached to the head connector 274 may be releasably engaged by one of the balls 285 and independently held on the shaft 206 thereby. In certain example embodiments, the configuration of the receptacles 282 and the balls 285 may be reversed such that the receptacles 282 are defined in the head connector 274 and the balls 285 are positioned along the internal circumferential surface of the shaft interface 258 of the head 208. However, it may be less expensive to provide the ball 285 and the spring 286 on the head connector 274 than to provide the ball 285 and the spring 286 on the head 208.

Each head 208 of the multi-driver tool 200 may be formed as an elongated member or assembly having a generally cylindrical and tubular shape that is sized and configured to be positioned on the head connector 254 of the working section 262 of the shaft 206, on the holder section 248 of the shaft 206, and within the internal cavity 214 of the handle 204. As shown, each head 208 may include two sockets 288 defined therein. In particular, each head 208 may include a first socket 288a defined in a first end of the head 208 and extending to the shaft interface 258 of the head 208, and a second socket 288b defined in the second end of the head 208 and extending to the shaft interface 258 of the head 208. In this manner, the shaft interface 258 may be positioned longitudinally between the first socket 288a and the second socket 288b, such that the shaft interface 258 and the sockets 288a, 288b collectively form an internal cavity that extends from the first end to the second end of the head 208. As shown, the first socket 288a may have a different size than the second socket 288b. In some example embodiments, the first socket 288a also may have a different configuration than the second socket 288b. In this manner, each head 208 may be reversible and configured to engage and drive two different fasteners of different sizes and/or configurations. The sockets 288a, 288b generally may be configured in a manner similar to conventional sockets. In certain example embodiments, as shown in FIG. 2F, each of the sockets 288a, 288b may include a chamfered lead-in surface 289, such that the corner between the internal sidewall of the socket 288a, 288b and the corresponding end wall of the head 208 is oriented at an acute angle relative to the longitudinal axis of the head 208. In other example embodiments, each of the sockets 288a, 288b may include a zero-chamfer lead-in surface, such that the corner between the internal sidewall of the socket 288a, 288b and the corresponding end wall of the head 208 is oriented at a right angle or a substantially right angle. Each of the sockets 288a, 288b may be sized and configured to engage standard size fasteners and may be sized in the same or different units. In certain example embodiments, the heads 208 may be formed of forged nickel plated steel, although other suitable materials may be used in other example embodiments.

As shown, the head connector 254 of the working section 246 of the shaft 206 may be sized and configured to be inserted into each of the heads 208 through either the first end or the second end of the head 208. In this manner, each of the heads 208 may be attached to the head connector 254 by inserting the head connector 254 through the first socket 288a and engaging the shaft interface 258 of the head 208 with the head connector 254 or by inserting the head connector 254 through the second socket 288b and engaging the shaft interface 258 of the head 208 with the head connector 254. When one of the heads 208 is attached to the head connector 254, the head connector 254 may engage the shaft interface 258 such that the head connector 254 and the head 208 rotate together during use of the multi-driver tool 200. In certain example embodiments, as shown in FIG. 2B, when one of the heads 208 is attached to the head connector 254, the distal end of the head connector 254 may be positioned at the internal end of the exposed socket 288a, 288b or proximally with respect to the internal end of the exposed socket 288a, 288b, such that the exposed socket 288a, 288b is free to receive a fastener therein. In other example embodiments, when one of the heads 208 is attached to the head connector 254, the distal end of the head connector 254 may be positioned within the exposed socket 288a, 288b. In certain example embodiments, when one of the heads 208 is attached to the head connector 254, the distal end of the head connector 254 may effectively form a portion of the internal end of the exposed socket 288a, 288b. In certain example embodiments, as shown, the head connector 254 may include a magnet 291 positioned at the distal end of the head connector 254 and configured to releasably retain a fastener at least partially within the exposed socket 288a, 288b.

As shown in FIG. 2B, a plurality of the heads 208 may be attached to the shaft 206 during use of the multi-driver tool 200. In particular, one or more of the heads 208 may be attached to the holder section 248 of the shaft 206 and stored within the internal cavity 214 of the handle 204, and one of the heads 208 may be attached to the working section 246 of the shaft 206 and “stored” thereon or used to drive a fastener. According to the illustrated embodiment, the multi-driver tool 200 includes three heads 208, with two of the heads 208 attached to the holder section 248 and stored within the internal cavity 214 and one of the heads 208 attached to the working section 246. It will be appreciated that use of a longer handle 204 including a longer internal cavity 214 and/or use of shorter heads 208 may allow a greater number of heads 208 to be stored within the internal cavity 214 of the handle 204. In certain example embodiments in which deeper sockets 288 are required, a single head 208 may be attached to the holder section 248 and stored within the internal cavity 214. In certain example embodiments in which the heads 208 are reversible, the number of different sockets 288 available to a user is double the number of heads 208 of the multi-driver tool 200. It will be appreciated that the sockets 288 of the heads 208 may differ in size (e.g., 3/16- 9/16 inches, etc.), in units (e.g., Imperial (SAE), metric, etc.), in shape (e.g., hexagonal, square, etc.), or combinations of these or other variables. The multi-driver tool 200 may provide a convenient configuration for storing and accessing a user's most commonly used heads 208. For example, commonly used heads 208 may be attached to the head connector 254 of the working section 246 or to the head connector 274 of the holder section 248 in the proximal-most position. The multi-driver tool 200 may be provided and sold as a kit that includes the handle 204, the shaft 206, and a variety of different heads 208. Alternatively, the handle 204 and the shaft 206 may be provided and sold separately from the heads 208, such that a user may individually select the heads 208 required by the user.

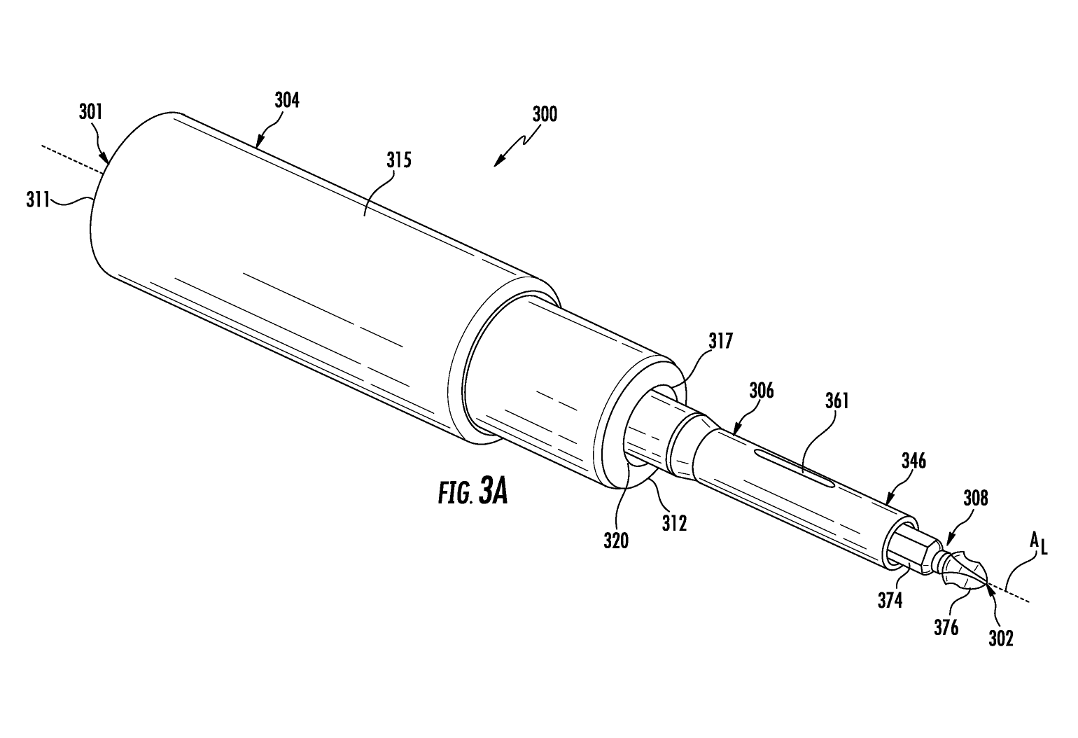

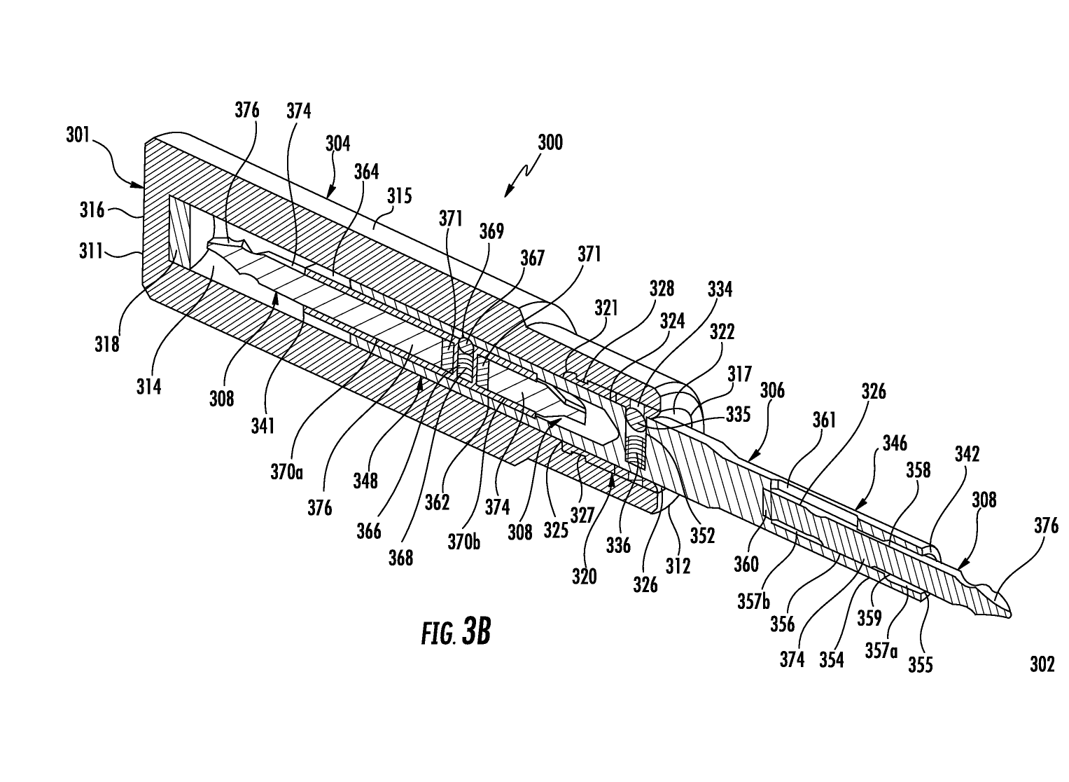

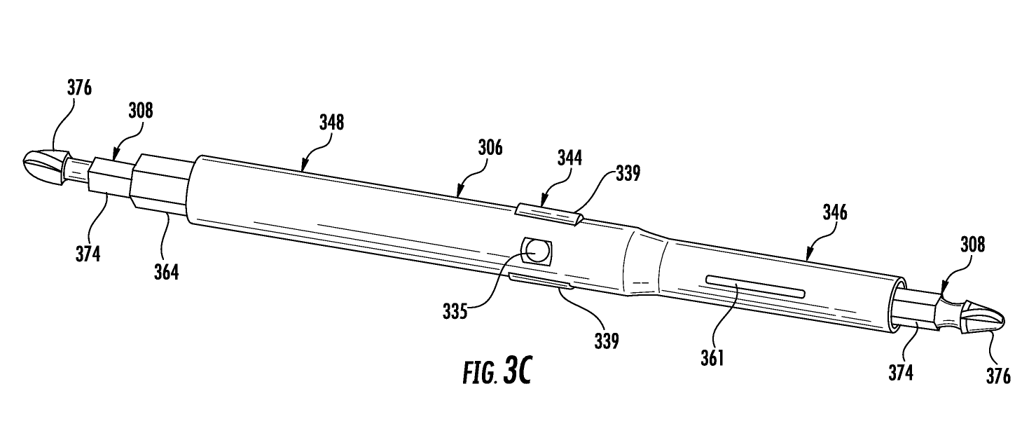

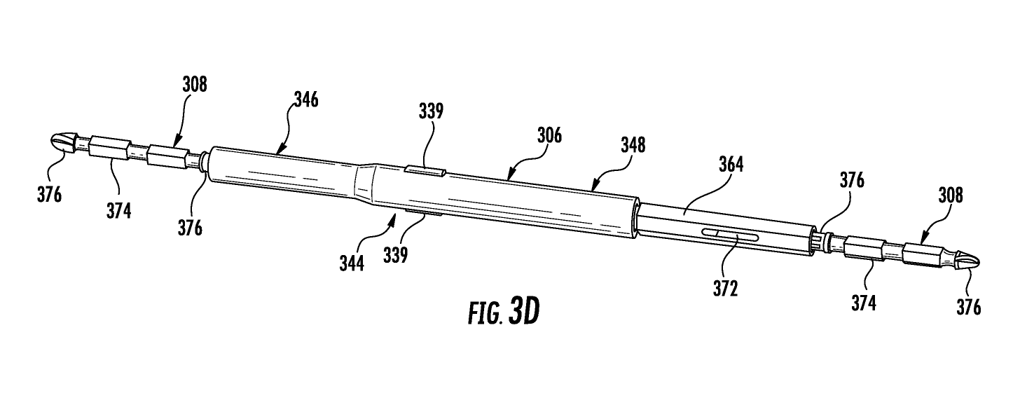

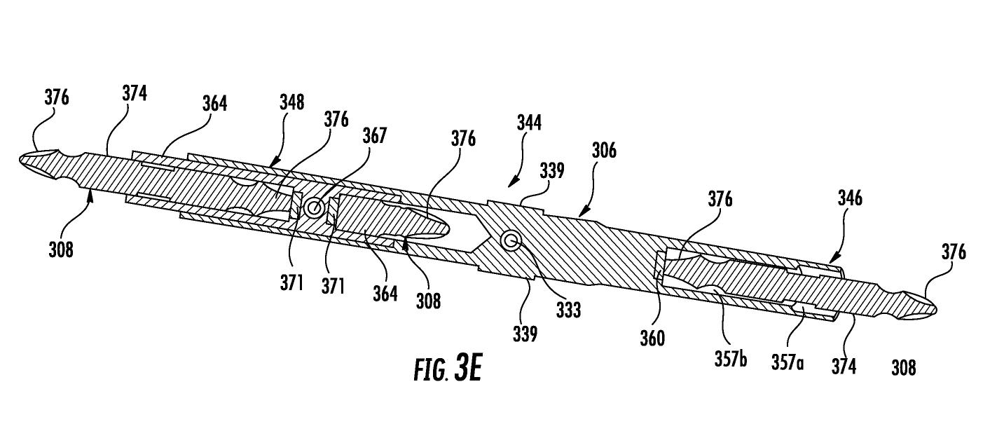

FIGS. 3A-3E illustrate a multi-driver tool 300 (which also may be referred to as a “multi-fastener-driver tool” or a “fastener-driver tool”) in accordance with one or more example embodiments of the disclosure. The multi-driver tool 300 may be used in various applications to drive nuts, screws, and/or other types of fasteners. As described below, the multi-driver tool 300 may include a handle, a shaft removably attached to the handle, and a number of heads each removably attached to the shaft. The multi-driver tool 300 may have an assembled configuration for driving a fastener with one of the heads, in which the shaft is attached to and positioned partially within the handle, one of the heads is attached to the shaft and positioned entirely outside of the handle, and one or more of the heads is attached to the shaft and positioned entirely within the handle. In this manner, when the multi-driver tool 300 is in the assembled configuration, the one of the heads may be used to drive a fastener, while the one or more of the heads may be stored and protected within the handle. The multi-driver tool 300 also may have a disassembled configuration for changing out the head to be used to drive a fastener, in which the shaft is detached from and positioned entirely outside of the handle. In this manner, when the multi-driver tool 300 is in the disassembled position, a user may detach two or more of the heads from the shaft and reattach the heads to the shaft in different positions, with a desired one of the heads in position to drive a fastener.

As compared to certain conventional multi-driver tools, embodiments of the multi-driver tool 300 may provide a compact and convenient configuration for securely storing and protecting multiple heads within the handle of the tool 300, may allow a user to change out the heads of the tool 300 in a straightforward and efficient manner, may allow a user to grasp the handle of the tool 300 in an ergonomic manner with the user's driving hand without disturbing the heads of the tool 300, may allow a user to grasp the shaft of the tool 300 in an ergonomic manner with the user's supporting hand without disturbing the heads of the tool 300, may allow a user to easily visualize a head attached to a working end of the shaft of the tool 300 and engage a fastener with the head, may avoid the need for an undesirably bulky handle of the tool 300, and/or may allow a user to store commonly-used heads of the tool 300 in an easily accessible position.

The multi-driver tool 300 may be formed as an elongated assembly having a longitudinal axis A_{L}, a proximal end 301 (which also may be referred to as a “user end” or a “first end”), and a distal end 302 (which also may be referred to as a “working end” or a “second end”). As shown in FIGS. 3A-3E, the multi-driver tool 300 may include a handle 304 (which also may be referred to as a “handle assembly”), a shaft 306 (which also may be referred to as a “shaft assembly”) attached to the handle 304, and a number of heads 308 (which also may be referred to individually as a “head assembly,” a “fastener-driving head,” a “bit,” a “tool bit,” or a “bit assembly”) attached to the shaft 306. In particular, the shaft 306 may be removably attached to the handle 304, and each of the heads 308 may be removably attached to the shaft 306, as described in detail below.

The multi-driver tool 300 may have an assembled configuration (which also may be referred to as a “driving configuration”), such as the configuration shown in FIGS. 3A and 3B, for driving a fastener with one of the heads 308. When the multi-driver tool 300 is in the assembled configuration, the shaft 306 may be attached to and positioned partially within the handle 304, one of the heads 308 may be attached to the shaft 306 and positioned entirely outside of the handle 304 (which may be referred to as a “driving position”), and one or more of the heads 308 may be attached to the shaft 306 and positioned entirely within the handle 304 (which may be referred to as a “storage position”), as shown. In this manner, the head 308 in the driving position may be used to drive a fastener, while the one or more heads 308 in the storage position may be stored and protected within the handle 304. In certain example embodiments, as shown, when the multi-driver tool 300 is in the assembled configuration, respective longitudinal axes of the handle 304, the shaft 306, and each of the heads 308 may be coaxial with one another and coaxial with the longitudinal axis A_{L} of the tool 300. The multi-driver tool 300 also may have a disassembled configuration (which also may be referred to as a “change-out configuration”) for changing out the head 308 in the driving position. When the multi-driver tool 300 is in the disassembled configuration, the shaft 306 may be detached from and positioned entirely outside of the handle 304. In this manner, when the multi-driver tool 300 is in the disassembled configuration, a user may detach two or more of the heads 308 from the shaft 306 and reattach the heads 308 to the shaft 306 in different positions. Following reattachment of the heads 308 to the shaft 306, the user may reattach the shaft 306 to the handle 304, with a desired one of the heads 308 in the driving position and the other heads 308 in the storage position, such that the multi-driver tool 300 is again in the assembled configuration for driving a fastener.

As shown in FIGS. 3A and 3B, the handle 304 may be formed as an elongated member or assembly having a generally cylindrical shape that is sized and configured to fit comfortably in the hand of a user. The handle 304 may have a longitudinal axis, a proximal end 311 (which also may be referred to as a “first end”), and a distal end 312 (which also may be referred to as a “second end”). The handle 304 may include and define an internal cavity 314 extending along the longitudinal axis of the handle 304. As described below, the internal cavity 314 may be configured to removably receive a portion of the shaft 306 and one or more of the heads 308 therein. As shown, the handle 304 may include a circumferential wall 315 extending about and spaced apart from the longitudinal axis of the handle 304, an end wall 316 (which also may be referred to as a “proximal end wall”) positioned at the proximal end 311 of the handle 304, and an opening 317 (which also may be referred to as a “distal opening”) defined in the distal end 312 of the handle 304 and in communication with the internal cavity 314. In this manner, the internal cavity 314 may be defined by the internal surfaces of the circumferential wall 315 and the end wall 316, the proximal end 311 of the handle 304 may be closed, and the distal end 312 of the handle 304 may be open such that the internal cavity 314 is accessible through the opening 317. In certain example embodiments, as shown, the internal cavity 314 may have a generally cylindrical shape, although other shapes of the internal cavity 314 may be used in other example embodiments. In certain example embodiments, the handle 304 may include a metal slug 318 positioned within the internal cavity 314 at the proximal end of the cavity 314 adjacent the end wall 316. In this manner, the metal slug 318 may protect the end wall 316 of the handle 304 from being impacted by heads 308 that are not fully seated on the shaft 306 when the shaft 306 is inserted into the internal cavity 314. The metal slug 318 may be particularly beneficial in embodiments in which the end wall 316 of the handle 304 is formed of a relatively soft material, such as plastic. The metal slug 318 may be insert molded into the handle 304 or may be inserted into the internal cavity 314 and secured in place by a separate attachment mechanism, such as an adhesive, a fastener, or the like. In certain example embodiments, such as embodiments in which the end wall 316 is formed of metal, the metal slug 318 may be omitted.

In certain example embodiments, the handle 304 may include a rigid core and a grip positioned over at least a portion of the rigid core and fixedly attached thereto. In this manner, the rigid core may provide structural integrity to the handle 304, and the grip may allow a user to securely grasp and manipulate the handle 304. In certain example embodiments, the grip may include an elastomer layer having a soft grip surface which may allow a user to easily grasp and manipulate the handle 304. In certain example embodiments, one or more of the external surfaces of the handle 304, such as the external surfaces of the rigid core and/or the grip, may include a geometry configured to facilitate manipulation of the handle 304 by a user. For example, one or more of the external surfaces of the handle 304 may include a textured surface, which may allow a user to easily grasp and manipulate the handle 304. The textured surface may include a number of grooves, ribs, protrusions, or other texturing features or patterns to facilitate gripping of the handle 304 by a user. In certain example embodiments, the textured surface or the soft grip surface of the handle 304 may be provided by forming an elastomer layer of the grip over the rigid core of the handle 304. For example, the elastomer layer may be overmolded on the rigid core. The handle 304, or at least the rigid core thereof, may be formed of any suitably strong, rigid material, such as metal, plastic or the like, or combinations of such materials. In certain example embodiments, the rigid core may be formed of a rigid cellulose acetate or polycarbonate, and the grip may be formed of a thermoplastic rubber (TPR) and polypropylene, although other suitable materials may be used for the rigid core and the grip in other example embodiments.

In certain example embodiments, the handle 304 may include a number of flat external surfaces that may be conveniently engaged and gripped by a separate tool, such as a wrench, pliers or the like. For example, the flat external surfaces of the handle 304 may form a square or hexagonal shape along the external circumference of the handle 304, which may be conveniently engaged and gripped by the separate tool. In some example embodiments, the handle 304 may include a receptacle defined in the proximal end 311 of the handle 304, such as in the end wall 316, and configured to receive a male end of a turning tool, such as a ratchet wrench. The receptacle may have a square or hexagonal shape, although other shapes of the receptacle may be used. In some example embodiments, the handle 304 may have a shape other than the generally cylindrical shape shown in the illustrated embodiment. For example, the handle 304 may have a T-shape, with laterally extending wings that extend outward from the circumferential wall 315 of the handle 304 and are configured to be gripped by a user to increase the torque applied to the multi-driver tool 300. The laterally extending wings may be movable, such as pivotable, relative to the circumferential wall 315 of the handle 304. In this manner, the wings may be deployed to extend from the circumferential wall 315 when the wings are in use and may be positioned against the circumferential wall 315 when the wings are not in use. It will be understood that the handle 304 may have a variety of shapes, sizes, and configurations in addition to those shown in the figures and described herein.

In certain example embodiments, the multi-driver tool 300 may include an insert bolster 320 attached to the handle 304 and positioned within the internal cavity 314 of the handle 304 adjacent the opening 317. The insert bolster 320 may be configured in the same or similar manner as the insert bolster 120 described above. As described below, the insert bolster 320 may be configured to provide a connection point for attaching the shaft 306 to the handle 304. As shown in FIG. 3B, the insert bolster 320 may be formed as an elongated member or assembly having a generally cylindrical and tubular shape that is sized and configured to be positioned within the internal cavity 314. The insert bolster 320 may have a longitudinal axis, a proximal end 321 (which also may be referred to as a “first end”), and a distal end 322 (which also may be referred to as a “second end”). The insert bolster 320 may include and define an internal bore 324 extending along the longitudinal axis of the insert bolster 320 from a proximal opening 325 defined in the proximal end 321 of the insert bolster 320 to a distal opening 326 defined in the distal end 322 of the insert bolster 320. The insert bolster 320 may be secured within the internal cavity 314 such that the insert bolster 320 is fixedly attached to and rotates with the handle 304. In this manner, the handle 304 and the insert bolster 320 may form a mechanically integrated assembly.

The insert bolster 320 may be fixedly attached to the handle 304 by a variety of connection mechanisms. In certain example embodiments, the insert bolster 320 may include a groove 327 (which also may be referred to as a “circumferential groove”) defined in the external circumferential surface of the insert bolster 320, as shown in FIG. 3B. The groove 327 may receive a mating projection 328 formed on the internal circumferential surface of the handle 304, as shown in FIG. 3B, such that the insert bolster 320 is axially fixed relative to the handle 304. In certain example embodiments, as shown, the projection 328 may have an annular shape extending along the entire internal circumferential surface of the handle 304. According to certain example embodiments in which the handle 304 is formed of plastic, the insert bolster 320 may be ultrasonically sealed to the handle 304 during manufacturing to permanently secure the insert bolster 320 to the handle 304. The ultrasonic process may involve melting the plastic of the handle 304 into the groove 327 to provide a permanent connection between the insert bolster 320 and the handle 304. In certain example embodiments, the insert bolster 320 may include a number of splines 331 (which also may be referred to as “linear ribs”) defined along the external circumferential surface of the insert bolster 320 and extending longitudinally along the insert bolster 320. The splines 331 of the insert bolster 320 may engage a number of splines 332 (which also may be referred to as “linear ribs”) defined along the internal circumferential surface of the handle 304 and extending longitudinally along the handle 304, such that the insert bolster 320 is prevented from rotating relative to the handle 304 about the longitudinal axis A_{L} of the multi-driver tool 300. In this manner, the insert bolster 320 may rotate with the handle 304 during use of the tool 300. In certain example embodiments, the insert bolster 320 may be formed of plated cast zinc. In certain example embodiments, the insert bolster 320 may be fixedly attached to the handle 304 by one or more fasteners, one or more adhesives, welding, or combinations of connection mechanisms. It will be understood that the insert bolster 320 may have a variety of shapes, sizes, and configurations in addition to those shown in the figures and described herein. In certain example embodiments, the insert bolster 320 may be omitted, and the features of the insert bolster 320 may be formed integrally with the handle 304 along the internal circumferential surface of the handle 304. In this manner, the handle 304 may provide the functionality of the insert bolster 320 described herein.

As shown in FIG. 3B, the insert bolster 320 may be configured to removably attach the shaft 306 to the handle 304. The insert bolster 320 may include a receptacle 334 (which also may be referred to as a “ball receptacle”) defined therein and configured to receive and releasably engage a ball 335 of the shaft 306 to retain a portion of the shaft 306 within the handle 304. The receptacle 334 may be formed as a hole defined in the insert bolster 320 and extending from the internal circumferential surface to the external circumferential surface of the insert bolster 320, as shown. Alternatively, the receptacle 334 may be formed as a detent defined in the internal circumferential surface of the insert bolster 320. The receptacle 334 of the insert bolster 320 may be sized and configured to receive the ball 335 of the shaft 306 in a snap-fit connection. In certain example embodiments, as shown, the ball 335 of the shaft 306 may be biased away from the longitudinal axis of the shaft 306 and toward the receptacle 334 of the insert bolster 320 by a spring 336 of the shaft 306 to facilitate the snap-fit connection. In certain example embodiments, the configuration of the receptacle 334 and the ball 335 may be reversed such that the receptacle 334 is defined in the shaft 306 and the ball 335 is positioned along the internal circumferential surface of the insert bolster 320. In certain example embodiments, the insert bolster 320 may be omitted, and the receptacle 334 may be defined in the internal circumferential surface of the handle 304 or the ball 335 may be positioned along the internal circumferential surface of the handle 304.

The insert bolster 320 may include one or more receptacles 338 (which also may be referred to as “female receptacles” or “projection receptacles”) defined in the internal circumferential surface of the insert bolster 320 and configured to receive one or more projections 339 (which also may be referred to as “male projections” or “ears”) of the shaft 306. The receptacles 338 of the insert bolster 320 may extend longitudinally along the insert bolster 320, and the projections 339 may extend longitudinally along the shaft 306, as shown. When the projections 339 are received within the receptacles 338, the connection between the receptacles 338 and the projections 339 may prevent rotation of the shaft 306 relative to the insert bolster 320 and the handle 304. In this manner, the connection between the receptacles 338 and the projections 339 may provide a torque coupling between the shaft 306 and the insert bolster 320 and the handle 304, such that torque applied to the handle 304 by a user is transmitted to the shaft 306. In certain example embodiments, the configuration of the receptacles 338 and the projections 339 may be reversed such that the receptacles 338 are defined in the shaft 306 and the projections 339 are positioned along the internal circumferential surface of the insert bolster 320. In certain example embodiments, the insert bolster 320 may be omitted, and the receptacles 338 may be defined in the internal circumferential surface of the handle 304 or the projections 339 may be positioned along the internal circumferential surface of the handle 304. It will be understood that the insert bolster 320 may have a variety of shapes, sizes, and configurations in addition to those shown in the figures and described herein.

As shown in FIGS. 3A-3E, the shaft 306 may be formed as an elongated member or assembly having a longitudinal axis, a proximal end 341 (which also may be referred to as a “first end”), and a distal end 342 (which also may be referred to as a “second end”). The shaft 306 may include an interface section 344 (which also may be referred to as an “interface portion”), a working section 346 (which also may be referred to as a “working portion”), and a holder section 348 (which also may be referred to as a “holder portion”). The interface section 344, the working section 346, and the holder section 348 each may have an elongated shape extending along the longitudinal axis of the shaft 306. In certain example embodiments, the interface section 344, the working section 346, and the holder section 348 may be integrally formed with one another. In other example embodiments, portions of the interface section 344, the working section 346, and the holder section 348 may be separately formed and fixedly attached to one another to form the shaft 306. In certain example embodiments, the shaft 306 may be formed of steel, such as nickel chrome plated steel or Cr—V steel (SAE 6150), although other suitable materials may be used for the shaft 306.

As shown, the interface section 344 of the shaft 306 may be positioned generally at the longitudinal center of the shaft 306, although the interface section 344 does not have to be positioned at the exact longitudinal center of the shaft 306, depending on the relative lengths of the working section 346 and the holder section 348. The interface section 344 may include a receptacle 352 (which also may be referred to as a “ball receptacle” or a “ball and spring receptacle”) defined therein and extending radially with respect to the longitudinal axis of the shaft 306. In certain example embodiments, as shown, the receptacle 352 may be formed as a blind hole extending from an internal portion of the interface section 344 to the external circumferential surface of the interface section 344. As shown, the ball 335 and the spring 336 of the shaft 306 may be positioned within the receptacle 352 of the interface section 344 such that the spring 336 biases the ball 335 away from the longitudinal axis of the shaft 306. The interface section 344 also may include the projections 339 extending longitudinally along the external circumferential surface of the interface section 344 and configured to engage the receptacles 338 of the insert bolster 320 or the handle 304. The interface section 344 may be sized and configured to be relatively closely received within the internal bore 324 of the insert bolster 320 or within the internal cavity 314 of the handle 304 according to embodiments in which the insert bolster 320 is omitted.

When the multi-driver tool 300 is in the assembled configuration, the interface section 344 of the shaft 306 may be at least partially or entirely received within the handle 304. Further, when the multi-driver tool 300 is in the assembled configuration, the engagement features of interface section 344, such as the ball 335 and the projections 339, may engage the engagement features of the insert bolster 320 (or the handle 304 according to embodiments in which the insert bolster 320 is omitted), such as the receptacle 334 and the receptacles 338. In this manner, when the multi-driver tool 300 is in the assembled configuration, the shaft 306 may be removably attached to the handle 304 and relative rotation between the handle 304 and the shaft 306 may be prevented. In certain example embodiments, as shown, the external circumferential surface of the interface section 344 and the internal circumferential surface of the insert bolster 320 (or the handle 304 according to embodiments in which the insert bolster 320 is omitted) may have mating cylindrical shapes, and the interface section 344 may include the projections 339. In other example embodiments, the external circumferential surface of the interface section 344 and the internal circumferential surface of the insert bolster 320 (or the handle 304 according to embodiments in which the insert bolster 320 is omitted) may have other mating cross-sectional shapes, such as a square shape or a hexagonal shape, which prevent relative rotation between the handle 304 and the shaft 306, such that the projections 339 may be omitted from the interface section 344 and the receptacles 338 of the insert bolster 320 (or the handle 304 according to embodiments in which the insert bolster 320 is omitted) may be omitted.

As shown, the working section 346 of the shaft 306 may be formed as a cylindrical and tubular-shaped member and may be positioned distally with respect to the interface section 344. In particular, the working section 346 may extend longitudinally from the distal end of the interface section 344 to the distal end 342 of the shaft 306. The working section 346 may include a head connector 354 (which also may be referred to as a “head driving connector”) positioned at the distal end of the working section 346 and configured to removably attach one of the heads 308 to the shaft 306. As shown, the head connector 354 may include an opening 355 (which also may be referred to as a “distal opening”) defined in the distal end of the head connector 354, and a head cavity 356 (which also may be referred to as a “bit cavity”) defined in the head connector 354 and extending from the opening 355 to an internal end of the head cavity 356 within the head connector 354. The head cavity 356 may be configured to removably receive a portion of one of the heads 308 therein, as shown. As shown, the head cavity 356 hay include a number of sockets 357 defined therein. In particular, the head cavity 356 may include a first socket 357a extending from the opening 355 to an intermediate point 358 of the head cavity 356, and a second socket 357b extending from the intermediate point 358 to the internal end of the head cavity 356. As shown, the first socket 357a may have a cross-sectional dimension that is larger than a cross-sectional dimension of the second socket 357b. In this manner, the head cavity 356 may include an abutment surface 359 positioned at the intermediate point 358. In certain example embodiments, the first socket 357a and the second socket 357b each may have a hexagonal cross-sectional shape. In certain example embodiments, the first socket 357a may have an approximately 5/16 inch hexagonal cross-sectional shape, and the second socket 357b may have an approximately ¼ inch hexagonal cross-sectional shape. In this manner, the first socket 357a may be configured to receive 5/16 inch heads, such as 5/16 inch bits, and the second socket 357b may be configured to receive ¼ inch heads, such as ¼ inch bits. It will be appreciated that the abutment surface 359 may prevent 5/16 inch heads from being inserted into the second socket 357b. In certain example embodiments, the head cavity 356 may include only one socket 357, which may extend along the entire length of the head cavity 356.

As shown in FIG. 3B, the working section 346 of the shaft 306 may include a magnet 360 positioned within the head cavity 356 at the internal end of the head cavity 356 and configured to releasably retain a head 308 within the second socket 357b of the head cavity 356. In certain example embodiments, the working section 346 also may include a second magnet positioned within the head cavity 356 at the abutment surface 359 of the head cavity 356 and configured to releasably retain a head 308 within the first socket 357a of the head cavity 356. As shown, the working section 346 may include an elongated slot 361 defined therein and in communication with the head cavity 356. The slot 361 may extend longitudinally along the length of the head connector 354 and may extend radially from the internal circumferential surface of the head cavity 356 to the external circumferential surface of the head connector 354. As shown, the slot 361 may have a distal end that is spaced apart from the distal end 342 of the shaft 306 and a proximal end that is positioned at or near the internal end of the head cavity 356. In this manner, the slot 361 may be used to facilitate removal of a mis-sized or mis-placed head inserted within the head cavity 356. In particular, a user may insert a portion of a tool, such as a tip of a small screwdriver, through the slot 361 and into the head cavity 356 to separate the mis-sized or misplaced head from the magnet 360 and push or pry the head out of the head cavity 356. Such use of the slot 361 may be particularly beneficial if a short head, such as a standard insert bit, having a length shorter than the length of the head cavity 356 is mistakenly inserted into the head cavity 356. Additionally, the slot 361 may allow a user to insert a portion of a tool through the slot 361 and into the head cavity 356 to dislodge and remove any foreign debris that may accumulate within the head cavity 356, particularly any metallic debris that may adhere to the magnet 360. Alternatively, a user may direct compressed air through the slot 361 and the head cavity 356 to dislodge and remove any foreign debris that may accumulate within the head cavity 356.

As shown, the holder section 348 of the shaft 306 may be formed as a cylindrical and tubular-shaped member and may be positioned proximally with respect to the interface section 344. In particular, the holder section 348 may extend longitudinally from the proximal end of the interface section 344 to the proximal end 341 of the shaft 306. The holder section 348 may include an internal cavity 362 defined therein and extending along the longitudinal axis of the shaft 306. In certain example embodiments, as shown, the internal cavity 362 may have a hexagonal cross-sectional shape. As shown, the internal cavity 362 may be configured to removably receive a head connector 364 (which also may be referred to as a “head holder,” a “holder,” or a “tool bit holder”) therein. The head connector 364 may have a cross-sectional shape that corresponds to the cross-sectional shape of the internal cavity 362 of the holder section 348, such that the head connector 364 rotates with the holder section 348. For example, the head connector 364 may have a hexagonal cross-sectional shape, as shown. The head connector 364 may include a receptacle 366 (which also may be referred to as a “ball receptacle” or a “ball and spring receptacle”) defined therein and extending radially with respect to the longitudinal axis of the head connector 364. In certain example embodiments, as shown, the receptacle 366 may be formed as a blind hole extending from an internal portion of the head connector 364 to the external circumferential surface of the head connector 364. As shown, a ball 367 and a spring 368 of the head connector 364 may be positioned within the receptacle 366 such that the spring 368 biases the ball 367 away from the longitudinal axis of the head connector 364. The ball 367 may be configured to be received within and releasably engage a receptacle 369 (which also may be referred to as a “ball receptacle”) defined in the internal circumferential surface of the internal cavity 362. In this manner, the head connector 364 may be removably attached to the holder section 348 of the shaft 306. The receptacle 369 may be formed as a detent defined in the internal circumferential surface of the internal cavity 361. Alternatively, the receptacle 369 may be formed as a hole defined in the holder section 348 and extending from the internal circumferential surface of the holder section 348 to or toward the external circumferential surface of the holder section 348. The receptacle 369 of the holder section 348 may be sized and configured to receive the ball 367 of the head connector 364 in a snap-fit connection. As shown, the ball 367 may be positioned on the head connector 364 such that the ball 367 is disposed opposite the receptacle 369 of the holder section 348 when the head connector 364 is received within the internal cavity 362. In certain example embodiments, the configuration of the receptacle 369 and the ball 367 may be reversed such that the receptacle 369 is defined in the head connector 364 and the ball 367 is positioned along the internal circumferential surface of the internal cavity 362 of the holder section 348.

As shown in FIG. 3B, the head connector 364 may include a pair of cavities 370 (which also may be referred to individually as a “bit cavity” or a “tool bit cavity”) defined in the head connector 364 and extending along the longitudinal axis of the head connector 364. In particular, the head connector 364 may include a first cavity 370a (which also may be referred to as a “proximal cavity”) defined therein and extending from the proximal end of the head connector 364 to an internal portion of the head connector 364, and a second cavity 370b (which also may be referred to as a “distal cavity”) defined therein and extending from the distal end of the head connector 364 to an internal portion of the head connector 364. As shown, the cavities 370a, 370b each may be configured to removably receive at least a portion of one of the heads 308 therein. In certain example embodiments, as shown, the first cavity 370a and the second cavity 370b each may have a hexagonal cross-sectional shape. In certain example embodiments, the first cavity 370a may have an approximately ¼ inch hexagonal cross-sectional shape, and the second cavity 370b may have an approximately 5/16 inch hexagonal cross-sectional shape. In this manner, the first cavity 370a may be configured to receive ¼ inch heads 308, such as ¼ inch standard insert bits, and the second cavity 370b may be configured to receive 5/16 inch heads 308, such as ¼ inch power bits. As shown, the head connector 364 may include a pair of magnets 371, with one magnet 371 positioned within the first cavity 370a at the internal end of the first cavity 370a and configured to releasably retain the head 308 therein, and another magnet 371 positioned within the second cavity 370b at the internal end of the second cavity 370b and configured to releasably retain the head 308 therein. As shown in FIG. 3D, the head connector 364 may include an elongated slot 372 defined therein and in communication with the first cavity 370a. The slot 372 may extend longitudinally along the length of the head connector 364 and may extend radially from the internal circumferential surface of the first cavity 370a to the external circumferential surface of the head connector 364. As shown, the slot 372 may have a proximal end that is spaced apart from the proximal end of the head connector 364 and a distal end that is positioned at or near the internal end of the first cavity 370a. In this manner, the slot 372 may be used to facilitate removal of a mis-sized or mis-placed head inserted within the first cavity 370a.

Each head 308 of the multi-driver tool 300 may be formed as an elongated member or assembly having a rod-like shape that is sized and configured to be removably received within the head connector 354 of the working section 346 of the shaft 306, within either the first cavity 370a or the second cavity 370b of the head connector 364 of the holder section 348 of the shaft 306, and within the internal cavity 314 of the handle 304. One or more of the heads 308 may be formed as a standard insert bit having an engagement section 374 and a single functional tip 376 extending from the engagement section 374. For example, as shown in FIG. 3B, the head 308 positioned within the second cavity 370b may be formed as a standard insert bit. One or more of the heads 308 may be formed as a double-ended power bit (i.e., a bit specifically designed to work in power tool impact drivers and drills and typically having a length of 2⅜ inches) having an engagement section 374 and a pair of functional tips 376 extending in opposite directions from the engagement section 374. For example, as shown in FIG. 3B, the head 308 positioned within the first cavity 370a may be formed as a double-ended power bit. The engagement sections 374 of the heads 308 may have a ¼ inch hexagonal cross-sectional shape or a 5/16 inch cross-sectional shape, although other sizes and shapes of the engagement sections 374 may be used. The functional tips 376 of the heads 308 may have a slotted configuration, a Phillips configuration, a Torx configuration, or any other configuration for mating with and driving various types of fasteners. In certain example embodiments, the heads 308 may be formed of forged nickel plated steel, although other suitable materials may be used in other example embodiments.

As shown in FIG. 3B, a plurality of the heads 308 may be attached to the shaft 306 during use of the multi-driver tool 300. In particular, one or more of the heads 308 may be attached to the head connector 364 of the holder section 348 of the shaft 306 and stored within the internal cavity 314 of the handle 304, and one of the heads 308 may be attached to the head connector 354 of the working section 346 of the shaft 306 and “stored” thereon or used to drive a fastener. According to the illustrated embodiment, the multi-driver tool 300 includes three heads 308, with two of the heads 308 attached to the holder section 348 and stored within the internal cavity 314 and one of the heads 308 attached to the working section 346. It will be appreciated that use of a longer handle 304 including a longer internal cavity 314 and/or use of shorter heads 308 may allow a greater number of heads 308 to be stored within the internal cavity 314 of the handle 304. In certain example embodiments in which longer heads 308 are required, a single head 308 may be attached to the holder section 348 and stored within the internal cavity 314. In certain example embodiments in which some or all of the heads 308 are reversible, the number of different functional tips 376 available to a user is greater than the number of heads 308 of the multi-driver tool 300. It will be appreciated that the functional tips 376 of the heads 308 may differ in size, in units (e.g., Imperial (SAE), metric, etc.), in shape (e.g., slotted, Phillips, Torx, etc.), or combinations of these or other variables. The multi-driver tool 300 may provide a convenient configuration for storing and accessing a user's most commonly used heads 308. For example, commonly used heads 308 may be attached to the head connector 354 of the working section 346 or to the head connector 364 of the holder section 348 in the first cavity 370a. The multi-driver tool 300 may be provided and sold as a kit that includes the handle 304, the shaft 306, and a variety of different heads 308. Alternatively, the handle 304 and the shaft 306 may be provided and sold separately from the heads 308, such that a user may individually select the heads 308 required by the user.

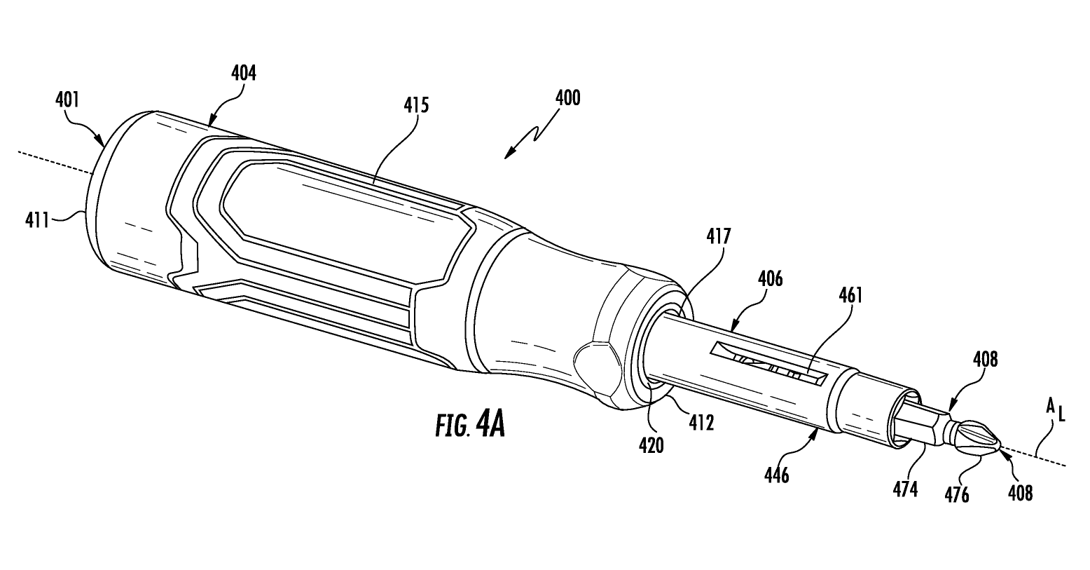

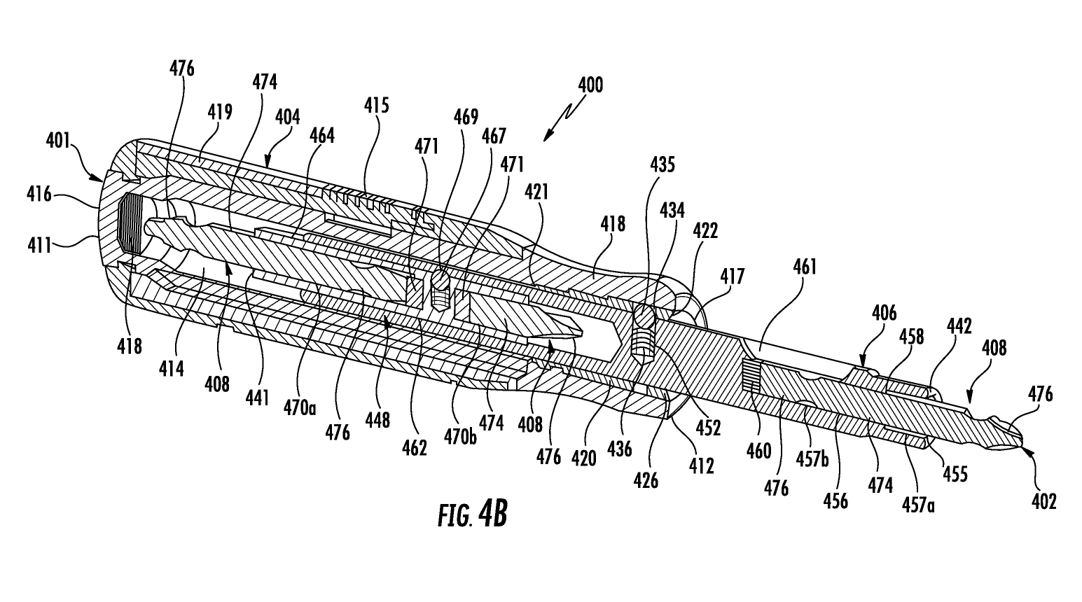

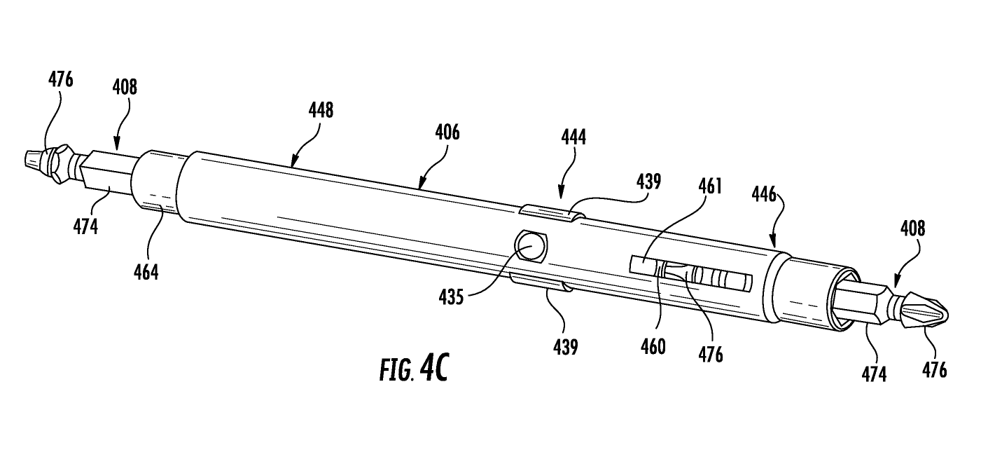

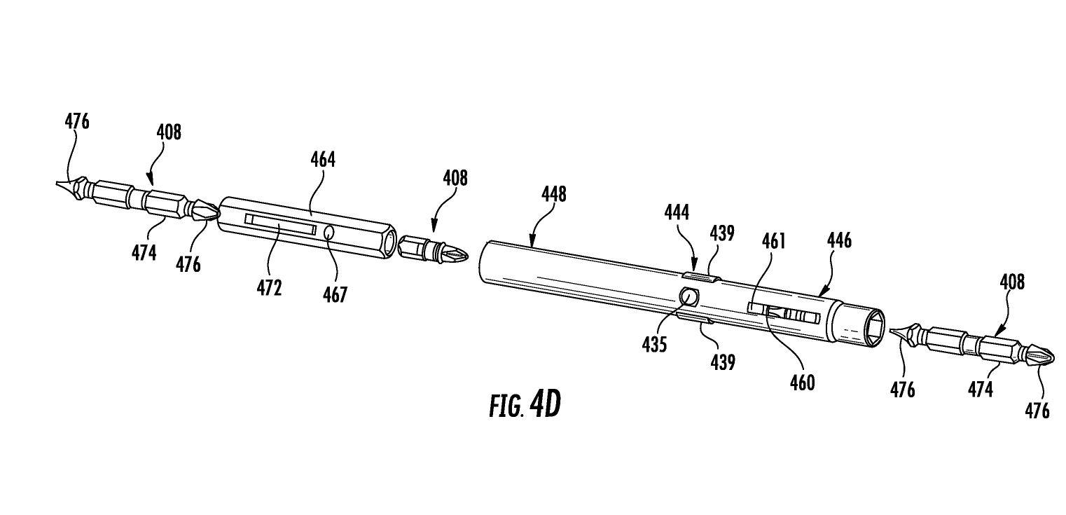

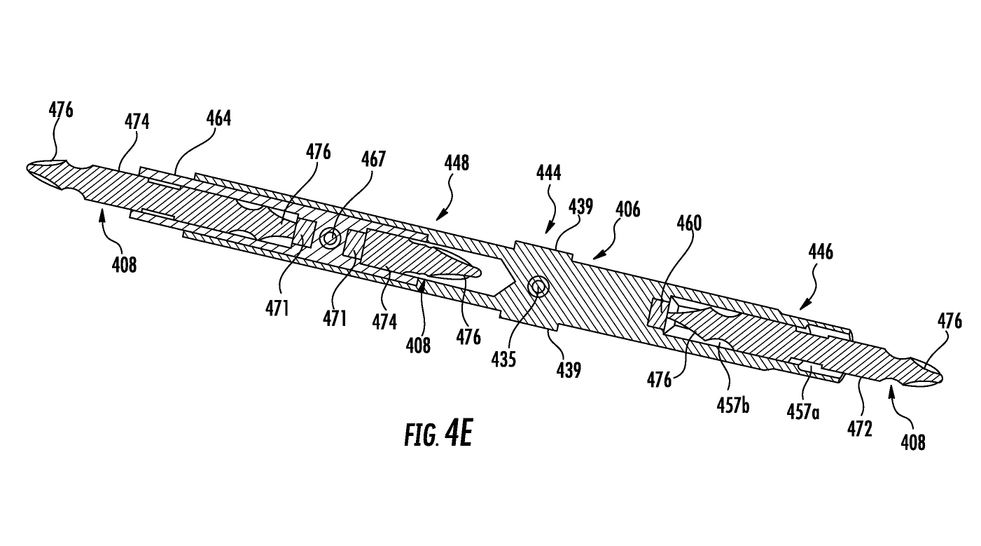

FIGS. 4A-4E illustrate a multi-driver tool 400 (which also may be referred to as a “multi-fastener-driver tool” or a “fastener-driver tool”) in accordance with one or more example embodiments of the disclosure. The multi-driver tool 400 may be used in various applications to drive nuts, screws, and/or other types of fasteners. As described below, the multi-driver tool 400 may include a handle, a shaft removably attached to the handle, and a number of heads each removably attached to the shaft. The multi-driver tool 400 may have an assembled configuration for driving a fastener with one of the heads, in which the shaft is attached to and positioned partially within the handle, one of the heads is attached to the shaft and positioned entirely outside of the handle, and one or more of the heads is attached to the shaft and positioned entirely within the handle. In this manner, when the multi-driver tool 400 is in the assembled configuration, the one of the heads may be used to drive a fastener, while the one or more of the heads may be stored and protected within the handle. The multi-driver tool 400 also may have a disassembled configuration for changing out the head to be used to drive a fastener, in which the shaft is detached from and positioned entirely outside of the handle. In this manner, when the multi-driver tool 400 is in the disassembled position, a user may detach two or more of the heads from the shaft and reattach the heads to the shaft in different positions, with a desired one of the heads in position to drive a fastener.

As compared to certain conventional multi-driver tools, embodiments of the multi-driver tool 400 may provide a compact and convenient configuration for securely storing and protecting multiple heads within the handle of the tool 400, may allow a user to change out the heads of the tool 400 in a straightforward and efficient manner, may allow a user to grasp the handle of the tool 400 in an ergonomic manner with the user's driving hand without disturbing the heads of the tool 400, may allow a user to grasp the shaft of the tool 400 in an ergonomic manner with the user's supporting hand without disturbing the heads of the tool 400, may allow a user to easily visualize a head attached to a working end of the shaft of the tool 400 and engage a fastener with the head, may avoid the need for an undesirably bulky handle of the tool 400, and/or may allow a user to store commonly-used heads of the tool 400 in an easily accessible position.

The multi-driver tool 400 may be formed as an elongated assembly having a longitudinal axis A_{L}, a proximal end 401 (which also may be referred to as a “user end” or a “first end”), and a distal end 402 (which also may be referred to as a “working end” or a “second end”). As shown in FIGS. 4A-4E, the multi-driver tool 400 may include a handle 404 (which also may be referred to as a “handle assembly”), a shaft 406 (which also may be referred to as a “shaft assembly”) attached to the handle 404, and a number of heads 408 (which also may be referred to individually as a “head assembly,” a “fastener-driving head,” a “bit,” a “tool bit,” or a “bit assembly”) attached to the shaft 406. In particular, the shaft 406 may be removably attached to the handle 404, and each of the heads 408 may be removably attached to the shaft 406, as described in detail below.

The multi-driver tool 400 may have an assembled configuration (which also may be referred to as a “driving configuration”), such as the configuration shown in FIGS. 4A and 4B, for driving a fastener with one of the heads 408. When the multi-driver tool 400 is in the assembled configuration, the shaft 406 may be attached to and positioned partially within the handle 404, one of the heads 408 may be attached to the shaft 406 and positioned entirely outside of the handle 404 (which may be referred to as a “driving position”), and one or more of the heads 408 may be attached to the shaft 406 and positioned entirely within the handle 404 (which may be referred to as a “storage position”), as shown. In this manner, the head 408 in the driving position may be used to drive a fastener, while the one or more heads 408 in the storage position may be stored and protected within the handle 404. In certain example embodiments, as shown, when the multi-driver tool 400 is in the assembled configuration, respective longitudinal axes of the handle 404, the shaft 406, and each of the heads 408 may be coaxial with one another and coaxial with the longitudinal axis A_{L} of the tool 400. The multi-driver tool 400 also may have a disassembled configuration (which also may be referred to as a “change-out configuration”) for changing out the head 408 in the driving position. When the multi-driver tool 400 is in the disassembled configuration, the shaft 406 may be detached from and positioned entirely outside of the handle 404. In this manner, when the multi-driver tool 400 is in the disassembled configuration, a user may detach two or more of the heads 408 from the shaft 406 and reattach the heads 408 to the shaft 406 in different positions. Following reattachment of the heads 408 to the shaft 406, the user may reattach the shaft 406 to the handle 404, with a desired one of the heads 408 in the driving position and the other heads 408 in the storage position, such that the multi-driver tool 400 is again in the assembled configuration for driving a fastener.

As shown in FIGS. 4A and 4B, the handle 404 may be formed as an elongated member or assembly having a generally cylindrical shape that is sized and configured to fit comfortably in the hand of a user. The handle 404 may have a longitudinal axis, a proximal end 411 (which also may be referred to as a “first end”), and a distal end 412 (which also may be referred to as a “second end”). The handle 404 may include and define an internal cavity 414 extending along the longitudinal axis of the handle 404. As described below, the internal cavity 414 may be configured to removably receive a portion of the shaft 406 and one or more of the heads 408 therein. As shown, the handle 404 may include a circumferential wall 415 extending about and spaced apart from the longitudinal axis of the handle 404, an end wall 416 (which also may be referred to as a “proximal end wall”) positioned at the proximal end 411 of the handle 404, and an opening 417 (which also may be referred to as a “distal opening”) defined in the distal end 412 of the handle 404 and in communication with the internal cavity 414. In this manner, the internal cavity 414 may be defined by the internal surfaces of the circumferential wall 415 and the end wall 416, the proximal end 411 of the handle 404 may be closed, and the distal end 412 of the handle 404 may be open such that the internal cavity 414 is accessible through the opening 417. In certain example embodiments, as shown, the internal cavity 414 may have a generally cylindrical shape, although other shapes of the internal cavity 414 may be used in other example embodiments.

In certain example embodiments, the handle 404 may include a rigid core 418 and a grip 419 positioned over at least a portion of the rigid core 418 and fixedly attached thereto. In this manner, the rigid core 418 may provide structural integrity to the handle 404, and the grip 419 may allow a user to securely grasp and manipulate the handle 404. In certain example embodiments, the grip 419 may include an elastomer layer having a soft grip surface which may allow a user to easily grasp and manipulate the handle 404. In certain example embodiments, one or more of the external surfaces of the handle 404, such as the external surfaces of the rigid core 418 and/or the grip 419, may include a geometry configured to facilitate manipulation of the handle 404 by a user. For example, one or more of the external surfaces of the handle 404 may include a textured surface, which may allow a user to easily grasp and manipulate the handle 404. The textured surface may include a number of grooves, ribs, protrusions, or other texturing features or patterns to facilitate gripping of the handle 404 by a user. In certain example embodiments, the textured surface or the soft grip surface of the handle 404 may be provided by forming an elastomer layer or portion of the grip 419 over the rigid core 418 of the handle 404. For example, the elastomer layer or portion may be overmolded on the rigid core 418. The handle 404, or at least the rigid core 418 thereof, may be formed of any suitably strong, rigid material, such as metal, plastic or the like, or combinations of such materials. In certain example embodiments, the rigid core 418 may be formed of a rigid cellulose acetate or polycarbonate, and the grip 419 may be formed of a thermoplastic rubber (TPR) and polypropylene, although other suitable materials may be used for the rigid core 418 and the grip 419 in other example embodiments. In certain example embodiments, the handle 404 may include a metal slug 418 positioned within the internal cavity 414 at the proximal end of the cavity 414 adjacent the end wall 416. In this manner, the metal slug 418 may protect the end wall 416 of the handle 404 from being impacted by heads 408 that are not fully seated on the shaft 406 when the shaft 406 is inserted into the internal cavity 414. The metal slug 418 may be particularly beneficial in embodiments in which the end wall 416 of the handle 404 is formed of a relatively soft material, such as plastic. The metal slug 418 may be insert molded into the handle 404 or may be inserted into the internal cavity 414 and secured in place by a separate attachment mechanism, such as an adhesive, a fastener, or the like. In certain example embodiments, such as embodiments in which the end wall 416 is formed of metal, the metal slug 418 may be omitted.

In certain example embodiments, the handle 404 may include a number of flat external surfaces that may be conveniently engaged and gripped by a separate tool, such as a wrench, pliers or the like. For example, the flat external surfaces of the handle 404 may form a square or hexagonal shape along the external circumference of the handle 404, which may be conveniently engaged and gripped by the separate tool. In some example embodiments, the handle 404 may include a receptacle defined in the proximal end 411 of the handle 404, such as in the end wall 416, and configured to receive a male end of a turning tool, such as a ratchet wrench. The receptacle may have a square or hexagonal shape, although other shapes of the receptacle may be used. In some example embodiments, the handle 404 may have a shape other than the generally cylindrical shape shown in the illustrated embodiment. For example, the handle 404 may have a T-shape, with laterally extending wings that extend outward from the circumferential wall 415 of the handle 404 and are configured to be gripped by a user to increase the torque applied to the multi-driver tool 400. The laterally extending wings may be movable, such as pivotable, relative to the circumferential wall 415 of the handle 404. In this manner, the wings may be deployed to extend from the circumferential wall 415 when the wings are in use and may be positioned against the circumferential wall 415 when the wings are not in use. It will be understood that the handle 404 may have a variety of shapes, sizes, and configurations in addition to those shown in the figures and described herein.

In certain example embodiments, the multi-driver tool 400 may include an insert bolster 420 attached to the handle 404 and positioned within the internal cavity 414 of the handle 404 adjacent the opening 417. The insert bolster 420 may be configured in the same or similar manner as the insert bolster 220 described above. As described below, the insert bolster 420 may be configured to provide a connection point for attaching the shaft 406 to the handle 404. As shown in FIG. 4B, the insert bolster 420 may be formed as an elongated member or assembly having a generally cylindrical and tubular shape that is sized and configured to be positioned within the internal cavity 414. The insert bolster 420 may have a longitudinal axis, a proximal end 421 (which also may be referred to as a “first end”), and a distal end 422 (which also may be referred to as a “second end”). The insert bolster 420 may include and define an internal bore 424 extending along the longitudinal axis of the insert bolster 420 from a proximal opening 425 defined in the proximal end 421 of the insert bolster 420 to a distal opening 426 defined in the distal end 422 of the insert bolster 420. The insert bolster 420 may be secured within the internal cavity 414 such that the insert bolster 420 is fixedly attached to and rotates with the handle 404. In this manner, the handle 404 and the insert bolster 420 may form a mechanically integrated assembly.

The insert bolster 420 may be fixedly attached to the handle 404 by a variety of connection mechanisms. In certain example embodiments, as shown, the insert bolster 420 may include a number of splines 431 (which also may be referred to as “linear ribs”) defined along the external circumferential surface of the insert bolster 420 and extending longitudinally along the insert bolster 420. The splines 431 of the insert bolster 420 may engage a number of splines 432 (which also may be referred to as “linear ribs”) defined along the internal circumferential surface of the handle 404 and extending longitudinally along the handle 404, such that the insert bolster 420 is prevented from rotating relative to the handle 404 about the longitudinal axis A_{L} of the multi-driver tool 400. In this manner, the insert bolster 420 may rotate with the handle 404 during use of the tool 400. In certain example embodiments, the insert bolster 420 may include a groove (which also may be referred to as a “circumferential groove”) defined in the external circumferential surface of the insert bolster 420. The groove may receive a mating projection formed on the internal circumferential surface of the handle 404 such that the insert bolster 420 is axially fixed relative to the handle 404. In certain example embodiments, the projection may have an annular shape extending along the entire internal circumferential surface of the handle 404. According to certain example embodiments in which the handle 404 is formed of plastic, the insert bolster 420 may be ultrasonically sealed to the handle 404 during manufacturing to permanently secure the insert bolster 420 to the handle 404. The ultrasonic process may involve melting the plastic of the handle 404 into the groove of the insert bolster 420 to provide a permanent connection between the insert bolster 420 and the handle 404. In certain example embodiments, the insert bolster 420 may be formed of plated cast zinc. In certain example embodiments, the insert bolster 420 may be fixedly attached to the handle 404 by one or more fasteners, one or more adhesives, welding, or combinations of connection mechanisms. It will be understood that the insert bolster 420 may have a variety of shapes, sizes, and configurations in addition to those shown in the figures and described herein. In certain example embodiments, the insert bolster 420 may be omitted, and the features of the insert bolster 420 may be formed integrally with the handle 404 along the internal circumferential surface of the handle 404. In this manner, the handle 404 may provide the functionality of the insert bolster 420 described herein.

As shown in FIG. 4B, the insert bolster 420 may be configured to removably attach the shaft 406 to the handle 404. The insert bolster 420 may include a receptacle 434 (which also may be referred to as a “ball receptacle”) defined therein and configured to receive and releasably engage a ball 435 of the shaft 406 to retain a portion of the shaft 406 within the handle 404. The receptacle 434 may be formed as a hole defined in the insert bolster 420 and extending from the internal circumferential surface to the external circumferential surface of the insert bolster 420, as shown. Alternatively, the receptacle 434 may be formed as a detent defined in the internal circumferential surface of the insert bolster 420. The receptacle 434 of the insert bolster 420 may be sized and configured to receive the ball 435 of the shaft 406 in a snap-fit connection. In certain example embodiments, as shown, the ball 435 of the shaft 406 may be biased away from the longitudinal axis of the shaft 406 and toward the receptacle 434 of the insert bolster 420 by a spring 436 of the shaft 406 to facilitate the snap-fit connection. In certain example embodiments, the configuration of the receptacle 434 and the ball 435 may be reversed such that the receptacle 434 is defined in the shaft 406 and the ball 435 is positioned along the internal circumferential surface of the insert bolster 420. In certain example embodiments, the insert bolster 420 may be omitted, and the receptacle 434 may be defined in the internal circumferential surface of the handle 404 or the ball 435 may be positioned along the internal circumferential surface of the handle 404.

The insert bolster 420 may include one or more receptacles 438 (which also may be referred to as “female receptacles” or “projection receptacles”) defined in the internal circumferential surface of the insert bolster 420 and configured to receive one or more projections 439 (which also may be referred to as “male projections” or “ears”) of the shaft 406. The receptacles 438 of the insert bolster 420 may extend longitudinally along the insert bolster 420, and the projections 439 may extend longitudinally along the shaft 406, as shown. When the projections 439 are received within the receptacles 438, the connection between the receptacles 438 and the projections 439 may prevent rotation of the shaft 406 relative to the insert bolster 420 and the handle 404. In this manner, the connection between the receptacles 438 and the projections 439 may provide a torque coupling between the shaft 406 and the insert bolster 420 and the handle 404, such that torque applied to the handle 404 by a user is transmitted to the shaft 406. In certain example embodiments, the configuration of the receptacles 438 and the projections 439 may be reversed such that the receptacles 438 are defined in the shaft 406 and the projections 439 are positioned along the internal circumferential surface of the insert bolster 420. In certain example embodiments, the insert bolster 420 may be omitted, and the receptacles 438 may be defined in the internal circumferential surface of the handle 404 or the projections 439 may be positioned along the internal circumferential surface of the handle 404. It will be understood that the insert bolster 420 may have a variety of shapes, sizes, and configurations in addition to those shown in the figures and described herein.

As shown in FIGS. 4A-4E, the shaft 406 may be formed as an elongated member or assembly having a longitudinal axis, a proximal end 441 (which also may be referred to as a “first end”), and a distal end 442 (which also may be referred to as a “second end”). The shaft 406 may include an interface section 444 (which also may be referred to as an “interface portion”), a working section 446 (which also may be referred to as a “working portion”), and a holder section 448 (which also may be referred to as a “holder portion”). The interface section 444, the working section 446, and the holder section 448 each may have an elongated shape extending along the longitudinal axis of the shaft 406. In certain example embodiments, the interface section 444, the working section 446, and the holder section 448 may be integrally formed with one another. In other example embodiments, portions of the interface section 444, the working section 446, and the holder section 448 may be separately formed and fixedly attached to one another to form the shaft 406. In certain example embodiments, the shaft 406 may be formed of steel, such as nickel chrome plated steel or Cr—V steel (SAE 6150), although other suitable materials may be used for the shaft 406.

As shown, the interface section 444 of the shaft 406 may be positioned generally at the longitudinal center of the shaft 406, although the interface section 444 does not have to be positioned at the exact longitudinal center of the shaft 406, depending on the relative lengths of the working section 446 and the holder section 448. The interface section 444 may include a receptacle 452 (which also may be referred to as a “ball receptacle” or a “ball and spring receptacle”) defined therein and extending radially with respect to the longitudinal axis of the shaft 406. In certain example embodiments, as shown, the receptacle 452 may be formed as a blind hole extending from an internal portion of the interface section 444 to the external circumferential surface of the interface section 444. As shown, the ball 435 and the spring 436 of the shaft 406 may be positioned within the receptacle 452 of the interface section 444 such that the spring 436 biases the ball 435 away from the longitudinal axis of the shaft 406. The interface section 444 also may include the projections 439 extending longitudinally along the external circumferential surface of the interface section 444 and configured to engage the receptacles 438 of the insert bolster 420 or the handle 404. The interface section 444 may be sized and configured to be relatively closely received within the internal bore 424 of the insert bolster 420 or within the internal cavity 414 of the handle 404 according to embodiments in which the insert bolster 420 is omitted.

When the multi-driver tool 400 is in the assembled configuration, the interface section 444 of the shaft 406 may be at least partially or entirely received within the handle 404. Further, when the multi-driver tool 400 is in the assembled configuration, the engagement features of interface section 444, such as the ball 435 and the projections 439, may engage the engagement features of the insert bolster 420 (or the handle 404 according to embodiments in which the insert bolster 420 is omitted), such as the receptacle 434 and the receptacles 438. In this manner, when the multi-driver tool 400 is in the assembled configuration, the shaft 406 may be removably attached to the handle 404 and relative rotation between the handle 404 and the shaft 406 may be prevented. In certain example embodiments, as shown, the external circumferential surface of the interface section 444 and the internal circumferential surface of the insert bolster 420 (or the handle 404 according to embodiments in which the insert bolster 420 is omitted) may have mating cylindrical shapes, and the interface section 444 may include the projections 439. In other example embodiments, the external circumferential surface of the interface section 444 and the internal circumferential surface of the insert bolster 420 (or the handle 404 according to embodiments in which the insert bolster 420 is omitted) may have other mating cross-sectional shapes, such as a square shape or a hexagonal shape, which prevent relative rotation between the handle 404 and the shaft 406, such that the projections 439 may be omitted from the interface section 444 and the receptacles 438 of the insert bolster 420 (or the handle 404 according to embodiments in which the insert bolster 420 is omitted) may be omitted.

As shown, the working section 446 of the shaft 406 may be formed as a cylindrical and tubular-shaped member and may be positioned distally with respect to the interface section 444. In particular, the working section 446 may extend longitudinally from the distal end of the interface section 444 to the distal end 442 of the shaft 406. The working section 446 may include a head connector 454 (which also may be referred to as a “head driving connector”) positioned at the distal end of the working section 446 and configured to removably attach one of the heads 408 to the shaft 406. As shown, the head connector 454 may include an opening 455 (which also may be referred to as a “distal opening”) defined in the distal end of the head connector 454, and a head cavity 456 (which also may be referred to as a “bit cavity”) defined in the head connector 454 and extending from the opening 455 to an internal end of the head cavity 456 within the head connector 454. The head cavity 456 may be configured to removably receive a portion of one of the heads 408 therein, as shown. As shown, the head cavity 456 may include a number of sockets 457 defined therein. In particular, the head cavity 456 may include a first socket 457a extending from the opening 455 to an intermediate point 458 of the head cavity 456, and a second socket 457b extending from the intermediate point 458 to the internal end of the head cavity 456. As shown, the first socket 457a may have a cross-sectional dimension that is larger than a cross-sectional dimension of the second socket 457b. In this manner, the head cavity 456 may include an abutment surface 459 positioned at the intermediate point 458. In certain example embodiments, the first socket 457a and the second socket 457b each may have a hexagonal cross-sectional shape. In certain example embodiments, the first socket 457a may have an approximately 5/16 inch hexagonal cross-sectional shape, and the second socket 457b may have an approximately ¼ inch hexagonal cross-sectional shape. In this manner, the first socket 457a may be configured to receive 5/16 inch heads, such as 5/16 inch bits, and the second socket 457b may be configured to receive ¼ inch heads, such as ¼ inch bits. It will be appreciated that the abutment surface 459 may prevent 5/16 inch heads from being inserted into the second socket 457b. In certain example embodiments, the head cavity 456 may include only one socket 457, which may extend along the entire length of the head cavity 456.

As shown in FIG. 4B, the working section 446 of the shaft 406 may include a magnet 460 positioned within the head cavity 456 at the internal end of the head cavity 456 and configured to releasably retain a head 408 within the second socket 457b of the head cavity 456. In certain example embodiments, the working section 446 also may include a second magnet positioned within the head cavity 456 at the abutment surface 459 of the head cavity 456 and configured to releasably retain a head 408 within the first socket 457a of the head cavity 456. As shown, the working section 446 may include an elongated slot 461 defined therein and in communication with the head cavity 456. The slot 461 may extend longitudinally along the length of the head connector 454 and may extend radially from the internal circumferential surface of the head cavity 456 to the external circumferential surface of the head connector 454. The slot 461 may have a distal end that is spaced apart from the distal end 442 of the shaft 406 and a proximal end that is positioned at or near the internal end of the head cavity 456. In certain embodiments, as shown, the proximal end of the slot 461 may be spaced apart from and positioned proximally with respect to the distal end of the magnet 460. In this manner, the slot 461 may be used to facilitate removal of a mis-sized or mis-placed head inserted within the head cavity 456. In particular, a user may insert a portion of a tool, such as a tip of a small screwdriver, through the slot 461 and into the head cavity 456 to separate the mis-sized or misplaced head from the magnet 460 and push or pry the head out of the head cavity 456. Such use of the slot 461 may be particularly beneficial if a short head, such as a standard insert bit, having a length shorter than the length of the head cavity 456 is mistakenly inserted into the head cavity 456. Additionally, the slot 461 may allow a user to insert a portion of a tool through the slot 461 and into the head cavity 456 to dislodge and remove any foreign debris that may accumulate within the head cavity 456, particularly any metallic debris that may adhere to the magnet 460. Alternatively, a user may direct compressed air through the slot 461 and the head cavity 456 to dislodge and remove any foreign debris that may accumulate within the head cavity 456.

As shown, the holder section 448 of the shaft 406 may be formed as a cylindrical and tubular-shaped member and may be positioned proximally with respect to the interface section 444. In particular, the holder section 448 may extend longitudinally from the proximal end of the interface section 444 to the proximal end 441 of the shaft 406. The holder section 448 may include an internal cavity 462 defined therein and extending along the longitudinal axis of the shaft 406. In certain example embodiments, as shown, the internal cavity 462 may have a hexagonal cross-sectional shape. As shown, the internal cavity 462 may be configured to removably receive a head connector 464 (which also may be referred to as a “head holder,” a “holder,” or a “tool bit holder”) therein. The head connector 464 may have a cross-sectional shape that corresponds to the cross-sectional shape of the internal cavity 462 of the holder section 448, such that the head connector 464 rotates with the holder section 448. For example, the head connector 464 may have a hexagonal cross-sectional shape, as shown. The head connector 464 may include a receptacle 466 (which also may be referred to as a “ball receptacle” or a “ball and spring receptacle”) defined therein and extending radially with respect to the longitudinal axis of the head connector 464. In certain example embodiments, as shown, the receptacle 466 may be formed as a blind hole extending from an internal portion of the head connector 464 to the external circumferential surface of the head connector 464. As shown, a ball 467 and a spring 468 of the head connector 464 may be positioned within the receptacle 466 such that the spring 468 biases the ball 467 away from the longitudinal axis of the head connector 464. The ball 467 may be configured to be received within and releasably engage a receptacle 469 (which also may be referred to as a “ball receptacle”) defined in the internal circumferential surface of the internal cavity 462. In this manner, the head connector 464 may be removably attached to the holder section 448 of the shaft 406. The receptacle 469 may be formed as a detent defined in the internal circumferential surface of the internal cavity 461. Alternatively, the receptacle 469 may be formed as a hole defined in the holder section 448 and extending from the internal circumferential surface of the holder section 448 to or toward the external circumferential surface of the holder section 448. The receptacle 469 of the holder section 448 may be sized and configured to receive the ball 467 of the head connector 464 in a snap-fit connection. As shown, the ball 467 may be positioned on the head connector 464 such that the ball 467 is disposed opposite the receptacle 469 of the holder section 448 when the head connector 464 is received within the internal cavity 462. In certain example embodiments, the configuration of the receptacle 469 and the ball 467 may be reversed such that the receptacle 469 is defined in the head connector 464 and the ball 467 is positioned along the internal circumferential surface of the internal cavity 462 of the holder section 448.

As shown in FIG. 4B, the head connector 464 may include a pair of cavities 470 (which also may be referred to individually as a “bit cavity” or a “tool bit cavity”) defined in the head connector 464 and extending along the longitudinal axis of the head connector 464. In particular, the head connector 464 may include a first cavity 470a (which also may be referred to as a “proximal cavity”) defined therein and extending from the proximal end of the head connector 464 to an internal portion of the head connector 464, and a second cavity 470b (which also may be referred to as a “distal cavity”) defined therein and extending from the distal end of the head connector 464 to an internal portion of the head connector 464. As shown, the cavities 470a, 470b each may be configured to removably receive at least a portion of one of the heads 408 therein. In certain example embodiments, as shown, the first cavity 470a and the second cavity 470b each may have a hexagonal cross-sectional shape. In certain example embodiments, the first cavity 470a may have an approximately ¼ inch hexagonal cross-sectional shape, and the second cavity 470b may have an approximately 5/16 inch hexagonal cross-sectional shape. In this manner, the first cavity 470a may be configured to receive ¼ inch heads 408, such as ¼ inch standard insert bits, and the second cavity 470b may be configured to receive 5/16 inch heads 408, such as ¼ inch power bits. As shown, the head connector 464 may include a pair of magnets 471, with one magnet 471 positioned within the first cavity 470a at the internal end of the first cavity 470a and configured to releasably retain the head 408 therein, and another magnet 471 positioned within the second cavity 470b at the internal end of the second cavity 470b and configured to releasably retain the head 408 therein. As shown in FIG. 4D, the head connector 464 may include an elongated slot 472 defined therein and in communication with the first cavity 470a. The slot 472 may extend longitudinally along the length of the head connector 464 and may extend radially from the internal circumferential surface of the first cavity 470a to the external circumferential surface of the head connector 464. The slot 472 may have a proximal end that is spaced apart from the proximal end of the head connector 464 and a distal end that is positioned at or near the internal end of the first cavity 470a. In certain embodiments, as shown, the distal end of the slot 472 may be spaced apart from and positioned distally with respect to the proximal end of the magnet 471. In this manner, the slot 472 may be used to facilitate removal of a mis-sized or mis-placed head inserted within the first cavity 470a.

Each head 408 of the multi-driver tool 400 may be formed as an elongated member or assembly having a rod-like shape that is sized and configured to be removably received within the head connector 454 of the working section 446 of the shaft 406, within either the first cavity 470a or the second cavity 470b of the head connector 464 of the holder section 448 of the shaft 406, and within the internal cavity 414 of the handle 404. One or more of the heads 408 may be formed as a standard insert bit having an engagement section 474 and a single functional tip 476 extending from the engagement section 474. For example, as shown in FIG. 4B, the head 308 positioned within the second cavity 470b may be formed as a standard insert bit. One or more of the heads 408 may be formed as a double-ended power bit (i.e., a bit specifically designed to work in power tool impact drivers and drills and typically having a length of 2⅜ inches) having an engagement section 474 and a pair of functional tips 476 extending in opposite directions from the engagement section 474. For example, as shown in FIG. 4B, the head 408 positioned within the first cavity 470a may be formed as a double-ended power bit. The engagement sections 474 of the heads 408 may have a ¼ inch hexagonal cross-sectional shape or a 5/16 inch cross-sectional shape, although other sizes and shapes of the engagement sections 474 may be used. The functional tips 476 of the heads 408 may have a slotted configuration, a Phillips configuration, a Torx configuration, or any other configuration for mating with and driving various types of fasteners. In certain example embodiments, the heads 408 may be formed of forged nickel plated steel, although other suitable materials may be used in other example embodiments.

As shown in FIG. 4B, a plurality of the heads 408 may be attached to the shaft 406 during use of the multi-driver tool 400. In particular, one or more of the heads 408 may be attached to the head connector 464 of the holder section 448 of the shaft 406 and stored within the internal cavity 414 of the handle 404, and one of the heads 408 may be attached to the head connector 454 of the working section 446 of the shaft 406 and “stored” thereon or used to drive a fastener. According to the illustrated embodiment, the multi-driver tool 400 includes three heads 408, with two of the heads 408 attached to the holder section 448 and stored within the internal cavity 414 and one of the heads 408 attached to the working section 446. It will be appreciated that use of a longer handle 404 including a longer internal cavity 414 and/or use of shorter heads 408 may allow a greater number of heads 408 to be stored within the internal cavity 414 of the handle 404. In certain example embodiments in which longer heads 408 are required, a single head 408 may be attached to the holder section 448 and stored within the internal cavity 414. In certain example embodiments in which some or all of the heads 408 are reversible, the number of different functional tips 476 available to a user is greater than the number of heads 408 of the multi-driver tool 400. It will be appreciated that the functional tips 476 of the heads 408 may differ in size, in units (e.g., Imperial (SAE), metric, etc.), in shape (e.g., slotted, Phillips, Torx, etc.), or combinations of these or other variables. The multi-driver tool 400 may provide a convenient configuration for storing and accessing a user's most commonly used heads 408. For example, commonly used heads 408 may be attached to the head connector 454 of the working section 446 or to the head connector 464 of the holder section 448 in the first cavity 470a. The multi-driver tool 400 may be provided and sold as a kit that includes the handle 404, the shaft 406, and a variety of different heads 408. Alternatively, the handle 404 and the shaft 406 may be provided and sold separately from the heads 408, such that a user may individually select the heads 408 required by the user.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A multi-driver tool comprising:
a handle comprising an internal cavity;
a shaft removably attached to the handle, wherein the shaft is positioned partially within the internal cavity when the shaft is attached to the handle; and
a plurality of heads removably attached to the shaft, wherein one of the heads is attached to the shaft and positioned entirely outside of the handle when the shaft is attached to the handle, and wherein one or more of the heads are attached to the shaft and positioned entirely within the internal cavity when the shaft is attached to the handle.

2. The multi-driver tool of claim 1, wherein the handle comprises an opening defined in a distal end of the handle and in communication with the internal cavity, and wherein the shaft extends through the opening when the shaft is attached to the handle.

3. The multi-driver tool of claim 1, wherein the shaft comprises an interface section configured to removably attach the shaft to the handle, and wherein the interface section is positioned at least partially within the internal cavity when the shaft is attached to the handle.

4. The multi-driver tool of claim 3, wherein the interface section comprises a receptacle defined in the interface section, a ball received within the receptacle, and a spring received within the receptacle and configured to bias the ball.

5. The multi-driver tool of claim 3, wherein the shaft further comprises a working section configured to removably attach the one of the heads to the shaft, and wherein the working section is positioned entirely outside of the handle when the shaft is attached to the handle.

6. The multi-driver tool of claim 5, wherein the working section comprises a head connector positioned at a distal end of the working section, and wherein the head connector comprises: (i) an elongated member configured to be received within the one of the heads; or (ii) a head cavity configured to receive the one of the heads therein.

7. The multi-driver tool of claim 6, wherein the working section further comprises: (i) a receptacle defined in the head connector, a ball received within the receptacle, and a spring received within the receptacle and configured to bias the ball; or (ii) a magnet positioned within the head cavity.

8. The multi-driver tool of claim 3, wherein the shaft further comprises a holder section configured to removably attach the one or more of the heads to the shaft, and wherein the holder section is positioned entirely within the internal cavity when the shaft is attached to the handle.

9. The multi-driver tool of claim 8, wherein the holder section comprises a head connector positioned at a proximal end of the holder section, and wherein the head connector comprises: (i) an elongated member configured to be received within the one or more of the heads; or (ii) a plurality of head cavities configured to receive the one or more of the heads therein.

10. The multi-driver tool of claim 9, wherein the head connector further comprises: (i) a receptacle defined in the head connector, a ball received within the receptacle, and a spring received within the receptacle and configured to bias the ball; or (ii) a magnet positioned within each of the head cavities.

11. The multi-driver tool of claim 1, further comprising an insert bolster fixedly attached to the handle and positioned at least partially within the internal cavity, wherein the shaft is removably attached to the handle by the insert bolster.

12. The multi-driver tool of claim 11, wherein the shaft comprises a projection extending along a longitudinal axis of the shaft, wherein the insert bolster comprises a projection receptacle defined therein, and wherein the projection is received within the projection receptacle when the shaft is attached to the handle such that the shaft rotates with the handle.

13. The multi-driver tool of claim 1, wherein each of the heads comprises a first socket extending from a first end of the head and a second socket extending from a second end of the head, and wherein the first socket and the second socket have different sizes or cross-sectional shapes.

14. The multi-driver tool of claim 1, wherein each of the heads comprises an engagement section and one or more functional tips extending from the engagement section and configured to drive a fastener.

15. A multi-driver tool comprising:
a handle;
a shaft removably attached to the handle, wherein the shaft is positioned partially within the handle when the shaft is attached to the handle; and
a plurality of heads removably attached to the shaft, wherein one of the heads is attached to the shaft and positioned entirely outside of the handle when the shaft is attached to the handle, and wherein one or more of the heads is attached to the shaft and positioned entirely within the handle when the shaft is attached to the handle.

16. The multi-driver tool of claim 15, wherein the shaft comprises:
an interface section configured to removably attach the shaft to the handle, wherein the interface section is positioned at least partially within the handle when the shaft is attached to the handle;
a working section configured to removably attach the one of the heads to the shaft, wherein the working section is positioned entirely outside of the handle when the shaft is attached to the handle; and
a holder section configured to removably attach the one or more of the heads to the shaft, wherein the holder section is positioned entirely within the handle when the shaft is attached to the handle.

17. The multi-driver tool of claim 16, wherein each of the heads comprises a first socket extending from a first end of the head and a second socket extending from a second end of the head, and wherein the first socket and the second socket have different sizes or cross-sectional shapes.

18. The multi-driver tool of claim 16, wherein each of the heads comprises an engagement section and one or more functional tips extending from the engagement section and configured to drive a fastener.

19. A multi-driver tool comprising:
a handle; and
a shaft attached to the handle, the shaft comprising:
a head cavity extending from a distal end of the shaft to an internal end of the head cavity and configured to removably receive a head therein; and
a slot defined in the shaft and in communication with the head cavity.

20. The multi-driver tool of claim 19, wherein the slot extends along the longitudinal axis of the shaft and comprises a distal end spaced apart from the distal end of the shaft and a proximal end positioned at or near an internal end of the head cavity.

21. A tool bit holder comprising:
an elongated member comprising a first end and a second end;
a tool bit cavity extending from the first end or the second end of the elongated member to an internal end of the tool bit cavity, wherein the tool bit cavity has a hexagonal cross-sectional shape and is configured to receive at least a portion of a tool bit therein; and
a slot in communication with the tool bit cavity, wherein the slot extends from an external surface of the elongated member to the tool bit cavity.
